(19) United States
(12) Patent Application Publication
(10) Pub. No.: US 2002/0063714 A1
(43) Pub. Date: May 30, 2002

(54) Interactive, multimedia advertising systems and methods

(76) Inventors: Michael Haas, Costa Mesa, CA (US); Paul McDaniels, Costa Mesa, CA (US)

Correspondence Address: CONNORS ASSOCIATES, 1600 DOVE ST, SUITE 220, NEWPORT BEACH, CA, 92660

(21) Appl. No.: 09/969,890

(22) Filed: Oct. 3, 2001

Related U.S. Application Data
(60) Provisional application No. 60/237,779, filed on Oct. 4, 2000.

(51) Int. Cl. G06T 13/00

(52) U.S. Cl. 345/473

(57) ABSTRACT

Systems and methods for advertising animated images of an object employ a computer with a monitor screen for displaying the animated images and a player file loaded into the computer. The player file shows first and second movies simultaneously on the monitor screen. These first and second movies are composed in an authoring program in which (a) the first movie is a graphical element having a display area, and (b) the second movie is animated images of the object formatted for display in this area. The player file includes a functional control program that displays on the monitor screen a control element enabling a user to interact with the second movie as this second movie is displayed.

### RELATED PATENT APPLICATION

This application is a utility application based on U.S. provisional patent application Serial No. 60/237,779, entitled “Interactive Multimedia Advertising Systems and Methods,” filed Oct. 4, 2000. This related application is incorporated herein by reference and made a part of this application.

### BACKGROUND OF THE INVENTION

With the advent of a global electronic communication network, commonly called the internet or world wide web, it is now possible for anyone connected to this network (a) to access web sites promoting all sorts of goods and services, and (b) to conduct transactions over the network, such transactions commonly being referred to as e-commerce. There is a demand for interactive web sites that enable a user visiting a web site to interact by activating various control elements displayed on the monitor screen of the user's computer. Authoring software programs are available to enable web site developers to create scalable, interactive animation of the objects being displayed on the user's monitor screen. For example, these authoring software programs enable developers to create interactive, multimedia productions including music, graphical elements, animated movies, and even videos to be displayed on the user's screen simultaneously.

### SUMMARY OF THE INVENTION

This invention has several features, no single one of which is solely responsible for its desirable attributes. Without limiting the scope of this invention as expressed by the claims that follow, its more prominent features will now be discussed briefly. After considering this discussion, and particularly after reading the section entitled, “DETAILED DESCRIPTION OF THE PREFERRED EMBODIMENTS,” one will understand how the features of this invention provide its benefits, which include, but are not limited to, the presentation of interactive multimedia advertisements via e-mail, compact disk (CD), digital television, and the internet, especially advertisements for automotive vehicles.

This invention includes both systems and methods. The first feature is that the system displays animated images of an object. The system employs a computer with a monitor screen for displaying the animated images, and a player file loaded into the computer for showing first and second movies simultaneously on the monitor screen. These first and second movies are composed in an authoring program in which (a) the first movie is a graphical element having a display area, and (b) the second movie is animated images of the object. The second movie is formatted for display in the display area of the first movie. Preferably, the first movie is downloaded prior to the second movie.

The system's second feature is that the player file includes a functional control program providing a control element shown in the graphical element displayed on the monitor screen. This control element enables a user to interact with the second movie as this second movie is displayed in the display area. The control element enables the user to perform one or more of the following functions: (1) to run the second movie selectively in either a forward direction or a reverse direction while being displayed, (2) to select a zoom mode for enlarging or reducing the size of the image of the object being displayed on the monitor screen, (3) to select and display on the monitor screen a single frame of the movie being run, (4) the user to change the color of the image of the object being displayed on the monitor screen, (5) to change backgrounds of the image of the object being displayed on the monitor screen. A user may also manipulate a mouse of the computer to actuate the control element. For example, the user may manipulate the mouse's arrow to roll over the image of the object to rotate the image either clockwise or counter-clockwise.

The system's third feature is that it includes a reader file for accessing the player file and enabling the movies in the player file to be displayed on the monitor screen,

The first method of this invention calls for creating and displaying an animated image of a first object. This first method includes the steps of:

(a) taking in a predetermined sequence a series of individual photographs of the object, including portions any background matter,

(b) storing in the memory of a computer as individual digital images the individual photographs,

(c) editing the digital images to remove any image of the background matter (the images may be colorized)

(d) installing in the memory of the computer an authoring program for creating scalable, interactive animation of the edited and digital images, the authoring program being adapted to interact with a functional control program and having a storage section for imported digital images,

(e) importing into the storage section the edited digital images as individual bitmap images and storing the individual bitmap images in the predetermined sequence within the storage section, thereby enabling the authoring program to display on a screen of a computer monitor the individual bitmap images rapidly one after another to create an animated image of the object, and

(f) providing a functional control program that is interactive with the authoring program to display on the screen:

(A) a first control element that enables a user to select and to view on the screen the animated image of the object moving in either a forward direction or reverse direction through the sequence,

(B) a second control element that enables a user to select a zoom mode to modify the size of said animated image of the object, either increasing or decreasing the size of the animated image displayed on the screen, and to view on the screen the modified image,

(C) a third control element that enables a user to select any one of the individual bitmap images as a first frame of the animated image of the object.

In accordance with this first method, formatted and edited digital images of a second object are imported into the storage section as individual bitmap images. These individual bitmap images of the second object are stored in a predetermined sequence within the storage section. This enables the authoring program to display on the screen of the computer monitor the individual bitmap images rapidly one after another to create an animated image of the second object. The functional control program includes a fourth control element displayed on the screen that enables a user to switch between displaying on the screen the animated image of the second object and displaying on the screen the animated image of the first object. Preferably, the functional control program also includes a fifth control element displayed on the screen that enables a user to select one of a plurality of different backgrounds for the object being displayed on the screen. If images are colorized, the functional control program may be provided with a fifth control element displayed on the screen that enables a user to change the color of the object being displayed on the screen. The animated images may be transmitted via e-mail, stored on a compact disk, or accessed over a global electronic communications network. A plug-in program may be used that is compatible with the authoring program in a computer that a user employs to view on the user's computer monitor screen the animated image of the object.

The second method of this invention calls for advertising a vehicle wherein animated images of the vehicle are displayed on a monitor screen. This second method includes the steps of:

(a) creating within an authoring software program a first movie of the vehicle in motion showing the exterior of the vehicle,

(b) creating within the authoring software program a second movie of the vehicle showing the interior of the vehicle from the view point of an observer seated within the vehicle and observing different portions of the interior of the vehicle,

(c) providing a functional control program that displays on the monitor screen a control element that enables a user to view the first movie and the second movie.

In accordance with this second method, preferably, the functional control program enables the user to select for viewing on the monitor screen (a) the first movie or the second movie or (2) simultaneously viewing the first movie and the second movie. This second method may be conducted over a global electronic communication network and the functional control program enables the user to make a purchase of the vehicle being advertised. Where the second movie includes a panoramic image of the interior of the vehicle, the panoramic image includes windows through which a background scene appears as if being viewed by an observer seated within the vehicle. Preferably, there are a plurality of different background scenes provided and the functional control program enables the user to select one of these background scenes to be displayed as the panoramic image of the interior of the vehicle being displayed. The functional control program enables the user to select (1) a first scenario where it appears that the background scene changes dynamically as viewed by the observer looking through the windows from the interior of the vehicle as the vehicle rotates, or (2) a second scenario where it appears that the background scene remains static as viewed by the observer looking through the windows from the interior of the vehicle as the vehicle rotates.

The third method of this invention specifically calls for advertising a vehicle over a global electronic communications network. This third method includes the steps of:

(a) placing the vehicle on a stand that enables a camera to take photographs at different angles of the vehicle, including portions of the stand and any background matter,

(b) taking with a camera at different angles a series of individual photographs of the vehicle, including portions of the stand and any background matter,

(c) storing said individual photographs in a predetermined sequence in the memory of a computer as individual digital images,

(d) editing the digital images to remove any image of the stand and the background matter,

(e) formatting the edited digital images of the vehicle and storing in the memory of the computer the formatted edited digital images,

(f) installing in the memory of the computer an authoring program for creating scalable, interactive animation of the edited and formatted digital images, the authoring program being adapted to interact with a functional control program and having a storage section for imported digital images,

(g) importing into the storage section the formatted and edited digital images as individual bitmap images and storing the individual bitmap images in the predetermined sequence within the storage section, thereby enabling the authoring program to display on a screen of a computer monitor the individual bitmap images rotating in sequence through 360 degrees rapidly one after another to create a n animated image of the vehicle,

(h) installing a plug-in program that is compatible with the authoring program in a computer that a user employs to view on a monitor screen of the user's computer the animated image of the vehicle,

(i) providing a functional control program that is interactive with the authoring program to display on the screen:

(A) a first control element that enables a user to select and to view on the screen the animated image of the vehicle moving in either a forward direction or reverse direction through said sequence,

(B) a second control element that enables a user to select a zoom mode to modify the size of said animated image of the vehicle, either increasing or decreasing said size of the animated image displayed on the screen, and to view on the screen said modified image,

(C) a third control element that enables a user to select any one of the individual bitmap images as a first frame of the animated image of said object

(j) saving in the authoring program as an .swf file said animated image of the vehicle,

(k) installing in the user's computer a plug-in program that is compatible with the authoring program to enable the animated image to be viewed on the screen of the user's computer monitor, and

(l) embedding said .swf file within a html file adapted to be uploaded to a remote server in the global electronic communications network accessed by a user's browser.

The fourth method of this invention specifically calls for displaying on a monitor screen animated images of an object having an exterior and an interior. This fourth method includes the steps of:

(a) creating within an authoring software program a first movie of the object in motion showing the exterior of the object,

(b) creating within the authoring software program a second movie of the object showing the interior of the object from the view point of an observer positioned within the object and observing different portions of the interior as the object moves,

(c) providing a functional control program that displays on said screen a control element that enables a user to view the first movie and the second movie.

In accordance with this fourth method, the control element enables the user to perform one or more of the following steps (1) to run selectively the movies in either a forward direction or a reverse direction, (2) to select a zoom mode for enlarging or reducing the size of the image of the object being displayed on the monitor screen, (3) to select and display on the monitor screen a single frame of the movie being run, (4) to change the color of the image of the object being displayed on the monitor screen, (5) to change backgrounds of the image of the object being displayed on the monitor screen.

### DESCRIPTION OF THE DRAWING

The preferred embodiments of this invention, illustrating all its features, will now be discussed in detail. These embodiments depict the novel and non-obvious advertising systems and methods of this invention as shown in the accompanying drawing, which is for illustrative purposes only. This drawing includes the following figures (Figs.), with like numerals indicating like parts:

FIGS. 1 through 21 Depict the First Embodiment of this Invention

FIG. 1 is a schematic diagram of the advertising system of this invention which allows a user to access over the internet the player file of this invention enabling the user to interact with this file.

FIG. 2A is a schematic flow diagram illustrating the method of this invention for creating and displaying an animated image of an object, for example, an automotive vehicle such as illustrated in FIG. 4B.

FIG. 2B is an extension of the flow diagram shown in FIG. 2A.

FIG. 3 is a graphical element created in an authoring program that appears on the screen of the user when interacting with a web site advertising an object, in this example an automotive vehicle.

FIG. 3A is a sub-element of the graphical element shown in FIG. 3 depicting a display area and some of the control elements for interacting with the web site.

FIG. 3B is another sub-element of the graphical element shown in FIG. 3 depicting a controller having control elements used to set which track of music is being played and control elements to stop, play, forward and reverse the movie of the automotive vehicle being shown in the display area.

FIG. 3C is a third sub-element of the graphical element shown in FIG. 3 depicting a model drop down menu that displays a number of different models of the automotive vehicle being advertised.

FIG. 4A represents a first movie created in an authoring program depicting the various sub-elements assembled to form the graphical element shown in FIG. 3.

FIG. 4B represents a second movie created in an authoring program depicting twenty-three different frames arranged in sequence of the automotive vehicle in different positions as it is rotated step by step through 360 degrees; this second movie is displayed in the display area of the graphical element shown in FIG. 3.

FIG. 4C shows the vehicle model drop down menu of the graphical element activated and one model of the automotive vehicle displayed in the display area.

FIG. 4D is similar to FIG. 4C, except the model drop down menu shows a different one model of the automotive vehicle in the display area than that shown in FIG. 4C.

FIG. 4E shows the controller drop down menu of the graphical element activated and in a lowered position.

FIG. 5 is a portion of the window appearing on the developer's computer monitor screen that is displayed when the developer first opens the FLASH authoring software program.

FIG. 6 is a portion of the window in the FLASH authoring software program appearing on the developer's computer monitor screen that is used to set movie properties.

FIG. 7 is a portion of the window in the FLASH authoring software program appearing on the developer's computer monitor screen that is used to indicate that the import function is to be employed.

FIG. 8 is a portion of the window in the FLASH authoring software program appearing on the developer's computer monitor screen that is used to indicate what images are to be imported.

FIG. 9 is a portion of the window in the FLASH authoring software program appearing on the developer's computer monitor screen that is used to prompt the developer that the images will be imported as a sequence.

FIG. 10 is a portion of the window in the FLASH authoring software appearing on the developer's computer monitor screen showing that the images have been imported into the authoring software program in the desired sequence.

FIG. 11A is a portion of the window in the FLASH authoring software program appearing on the developer's computer monitor screen showing the controller sub-element of the graphic element.

FIG. 11B is a portion of the window in the FLASH authoring software program appearing on the developer's computer monitor screen showing the stop button on the controller sub-element of the graphic element.

FIG. 11C is a portion of the window in the FLASH authoring software program appearing on the developer's computer monitor screen showing the code for activating the stop button on the controller sub-element of the graphic element.

FIG. 11D is a portion of the window in the FLASH authoring software program appearing on the developer's computer monitor screen showing the code for the forward control button on the controller sub-element of the graphic element.

FIG. 11E is a portion of the window in the FLASH authoring software program appearing on the developer's computer monitor screen showing the code for the play button on the controller.

FIG. 11F is a portion of the window in the FLASH authoring software program appearing on the developer's computer monitor screen showing the code for the rewind button on the controller sub-element of the graphic element.

FIG. 11G is a portion of the window in the FLASH authoring software program appearing on the developer's computer monitor screen showing the music tracks on the controller sub-element of the graphic element.

FIG. 12 is a portion of the window in the FLASH authoring software program appearing on the developer's computer monitor screen showing (1) the model drop-down menu sub-element of the graphic element that displays a first set of models of the automotive vehicle, and (2) the code for the change model button in the reverse direction.

FIG. 12A is a portion of the window in the FLASH authoring software program appearing on the developer's computer monitor screen showing (1) the model drop-down menu sub-element of the graphic element that displays a second set of models of the automotive vehicle, and (2) the code for the change model button in the forward direction.

FIG. 12B is a portion of the window in the FLASH authoring software program appearing on the developer's computer monitor screen showing the graphical composition of the model drop-down menu control button.

FIG. 12C is a portion of the window in the FLASH authoring software program appearing on the developer's computer monitor screen showing the code for the model drop-down menu control button.

FIG. 12D is a portion of the window in the FLASH authoring software program appearing on the developer's computer monitor screen showing the graphical composition of the change model buttons.

FIG. 13 is a portion of the window in the FLASH authoring software program appearing on the developer's computer monitor screen showing the graphical composition of the color customization buttons.

FIG. 13A is a portion of the window in the FLASH authoring software program appearing on the developer's computer monitor screen showing the code for the color customization buttons.

FIG. 14 is a portion of the window in the FLASH authoring software program appearing on the developer's computer monitor screen showing the graphical composition of the background customization buttons.

FIG. 14A is a portion of the window in the FLASH authoring software program appearing on the developer's computer monitor screen showing the code for the background customization buttons.

FIG. 15 is a portion of the window in the FLASH authoring software program appearing on the developer's computer monitor screen showing the graphical composition of the zoom in and out buttons.

FIG. 15A is a portion of the window in the FLASH authoring software program appearing on the developer's computer monitor screen showing the code for the zoom in button.

FIG. 15B is a portion of the window in the FLASH authoring software program appearing on the developer's computer monitor screen showing the code for the zoom out button.

FIG. 16 is a portion of the window in the FLASH authoring software program appearing on the developer's computer monitor screen showing the graphical composition of the drag button on the slider control element.

FIG. 17 shows the screen of the user's monitor illustrating the user selecting a change in colors of the automotive vehicle being displayed in the display area.

FIG. 18 shows the screen of the user's monitor with the controller drop down menu and the model drop down menu both activated and the user selecting a change of background in which the vehicle is being displayed in the display area.

FIG. 19 shows the screen of the user's monitor illustrating the user activating the fast forward control button.

FIG. 20 shows the screen of the user's monitor illustrating the user activating a zoom button to reduce the size of the image being displayed.

FIG. 21 shows the screen of the user's monitor illustrating the user activating a zoom button to enlarge the size of the image being displayed.

FIGS. 22 through 30 Depict the Second Embodiment of this Invention

FIG. 22 is a graphical element created in an authoring program that appears on the screen of the user when interacting with a web site advertising an object, in this example an automotive vehicle, enabling the user to view movies of both the exterior and the interior of the automotive vehicle.

FIG. 23 is the graphical element shown in FIG. 22 with the model drop-down menu activated and the user pointing and clicking on a control element showing a first series of interiors for different models of the automotive vehicle.

FIG. 24 is the graphical element shown in FIG. 23 with the user pointing and clicking on a control element to advance a second series of interiors for different models of the automotive vehicle.

FIG. 25 is the graphical element shown in FIG. 23 with the user pointing and clicking on one window screen to select an interior of one of the models of the automotive vehicle, displaying a first section of this selected interior in the display area.

FIG. 25A is the graphical element shown in FIG. 25 with the user pointing and dragging a control element to the right to view a second section of the interior of the selected model with the background changing dynamically, as viewed by an observer in the interior.

FIG. 25B is the graphical element shown in FIG. 25 with the user pointing and continuing to drag a control element to the right to view a third section of the interior of the selected model with the background changing dynamically, as viewed by an observer in the interior.

FIG. 25C is the graphical element shown in FIG. 25 with the user pointing and continuing to drag a control element still further to the right to view a fourth section of the interior of the selected model with the background changing dynamically, as viewed by an observer in the interior.

FIG. 26 is the graphical element shown in FIG. 23 with the user pointing and clicking on a control element to change the background being displayed as viewed by an observer in the interior of a selected model.

FIGS. 27A through 27C is the graphical element shown in FIG. 25 with a different background selected and the user pointing and dragging a control element to view a first section of the interior (FIG. 27A), then a second section of the interior (FIG. 27B), and finally a third section of the interior (FIG. 27C), of the selected model with the background remaining static as viewed by an observer in the interior of a selected model.

FIGS. 28A through 28D depict creating a movie in one FLASH file of an interior of one model of the automotive vehicle being advertised, showing portions of the window in the FLASH authoring software program appearing on the developer's computer monitor screen as a panoramic 360 degree seamed photograph of the interior being loaded into one layer in the one FLASH file of the authoring program.

FIGS. 29A and 29B depict creating a movie in a second FLASH file of a desert background to be viewed synchronously with the movie shown in FIGS. 28A through 28D, showing portions of the window in the FLASH authoring software program appearing on the developer's computer monitor screen as a panoramic 360 degree seamed photograph of the desert background is loaded into one layer of the second FLASH file.

FIG. 30 shows a portion of the window in the FLASH authoring software program appearing on the developer's computer monitor screen as the second movie depicted in FIGS. 29A and 29B is loaded in a layer of the first FLASH file of the movie depicted in FIGS. 28A through 28D.

### DETAILED DESCRIPTION OF THE PREFERRED EMBODIMENTS

First Embodiment:

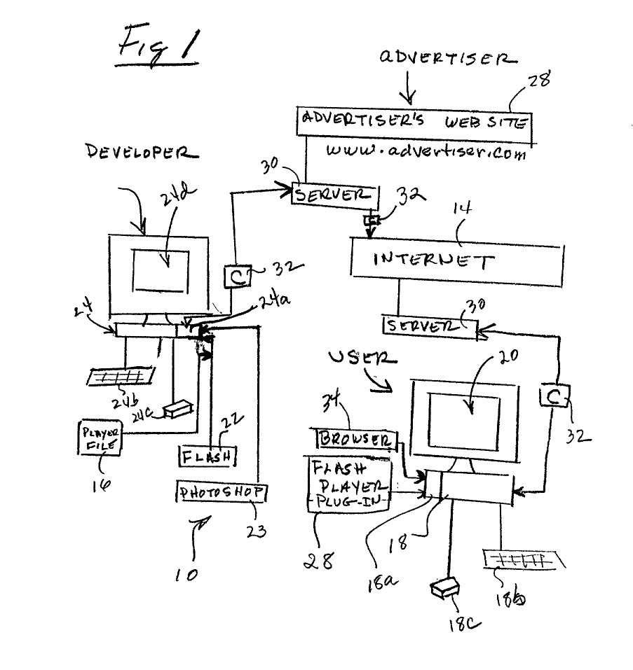

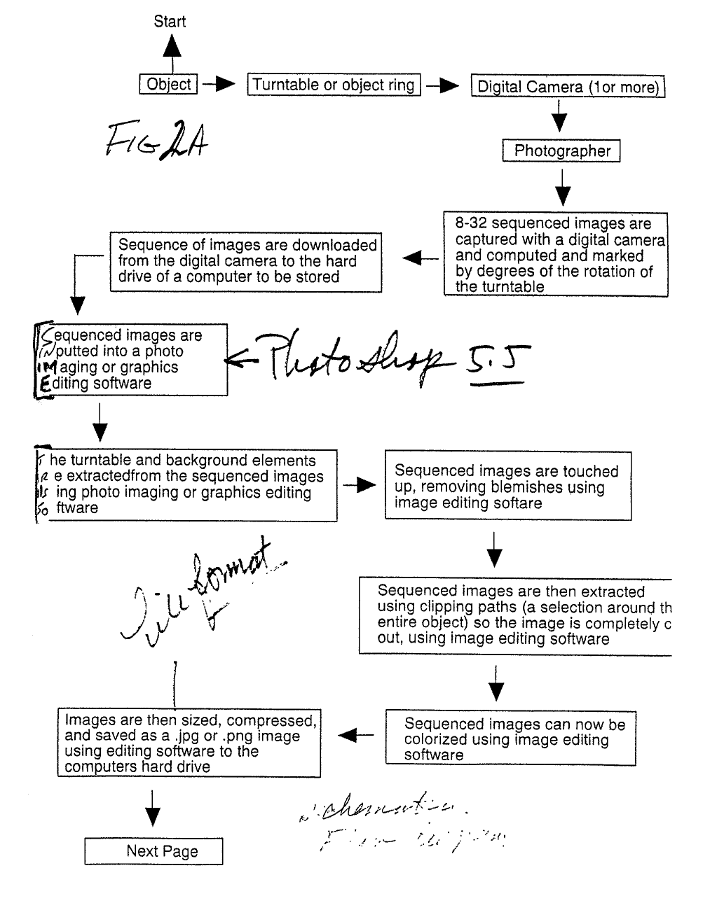

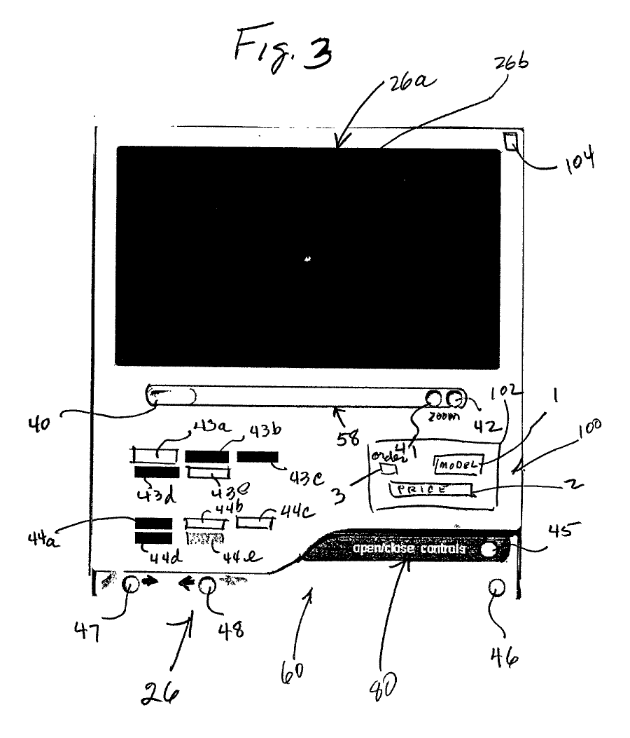

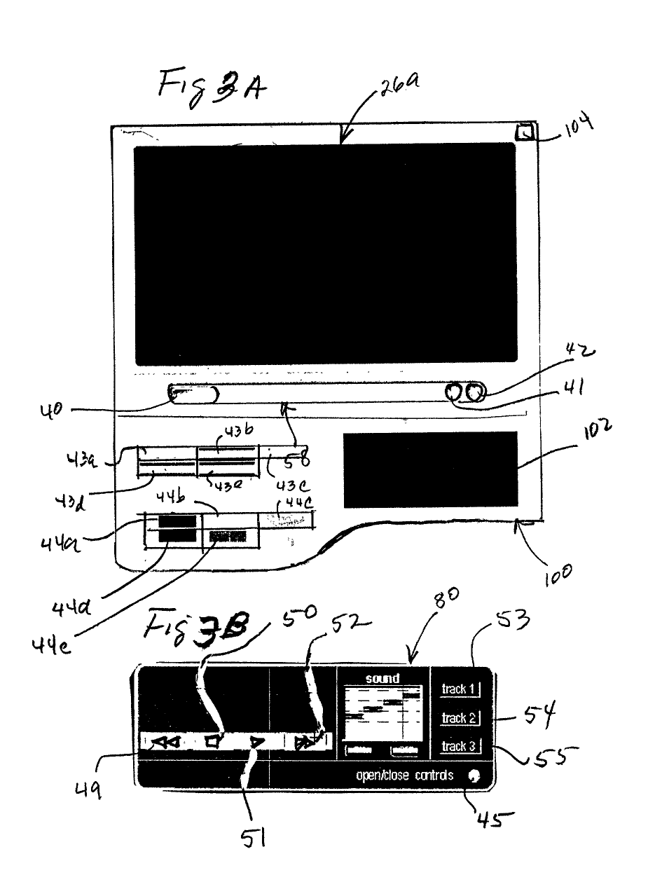

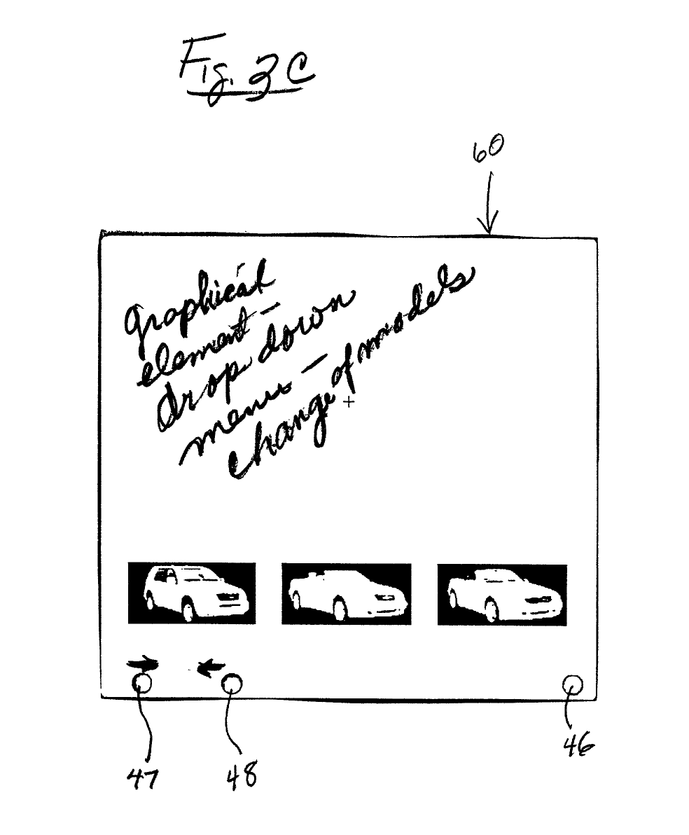

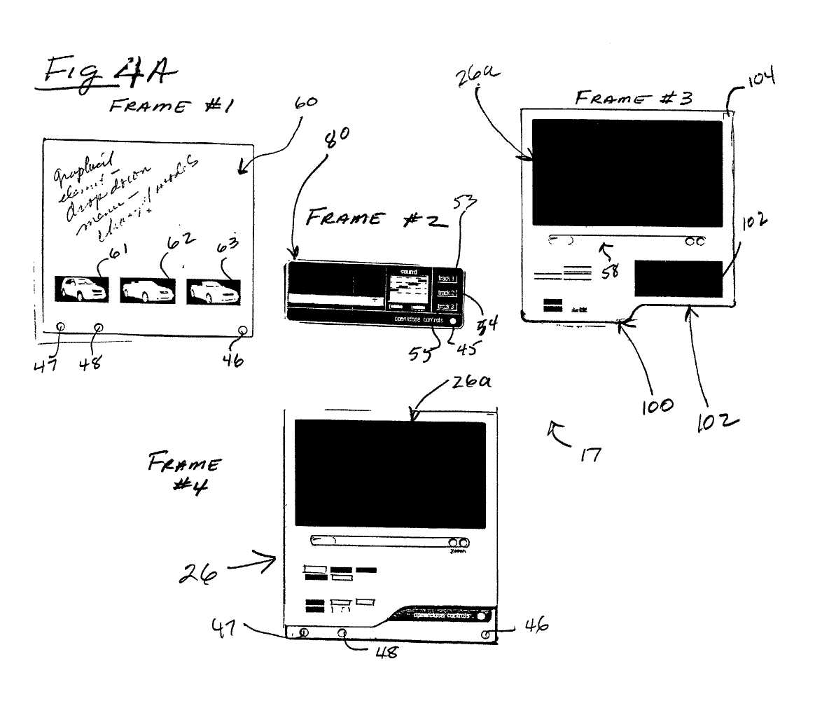

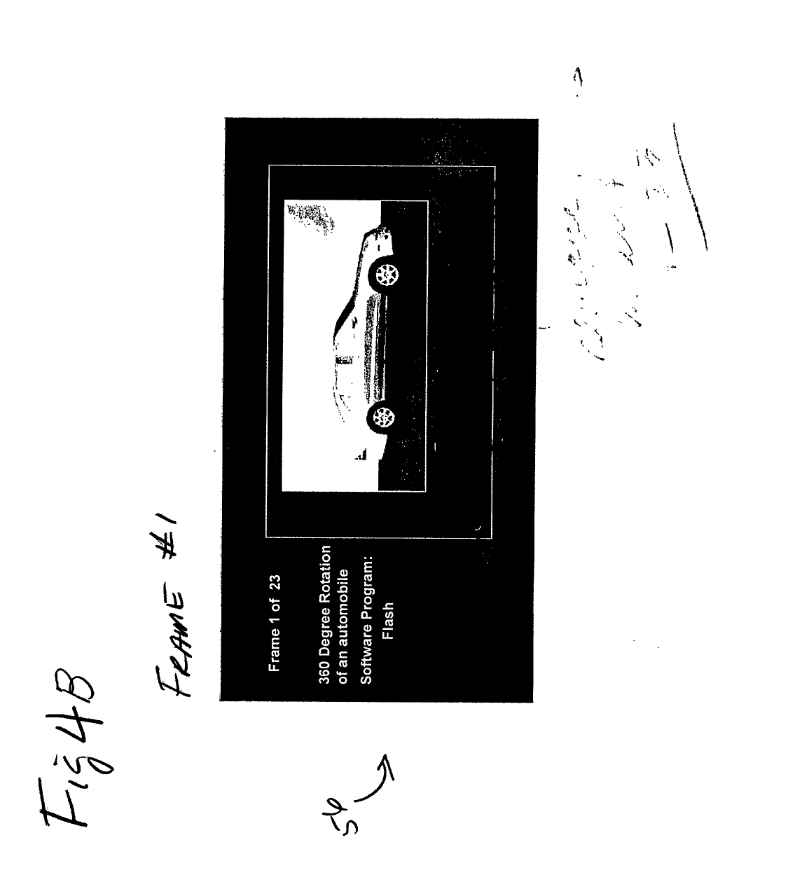

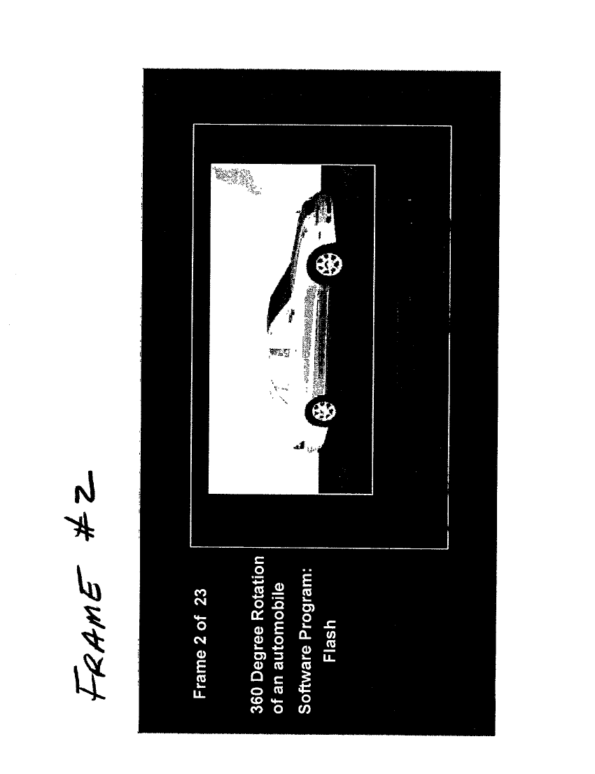

As shown in FIG. 1, the advertising system 10 of this invention is especially designed to be used with a global electronic communication network such as the internet 14. A software program identified as the player file 16 used in this invention is downloaded to a hard disk 18a of a user's computer 18 to enable the user to interact with an image of the object that is being advertised and displayed on the monitor screen 20 of the user's computer. In alternate embodiments of this invention, the player file 16 may be transferred to the user's computer 18 by email, by cable to a television screen (as used herein a television screen is equivalent to a monitor screen), or on a CD. In one preferred embodiment this object is an automotive vehicle. Other objects that particularly lend themselves for advertising using the advertising systems and methods of this invention are clothing such as, for example, hats, shirts, suits, dresses, pants, etc.; electronic devices such as, for example, televisions, radios, camcorders, audio equipment, computers, and any object that is of a size that conveniently may be rotated and photographed in a step wise, sequenced manner The player file 16 comprises at least two movies. Preferably, it also has several different music tracks that are audible when the user is viewing the advertisement being displayed on the monitor screen 20. The player file 16 is created using the “FLASH 4.0” authoring software program manufactured by Macromedia, Inc. of San Francisco, Calif. Although FLASH is the preferred authoring software program, other authoring software programs are available, some with even advanced features such as compression for videos, commonly referred to as Codecs, that allows videos to be included in the multimedia advertisement to be displayed on the monitor screen 20 of the user's computer 18. The authoring software 22 is loaded into a hard drive 24a of a developer's computer 24 at which the developer creates the player file 16. The developer then creates using the authoring software 22 the movies to be displayed on the user's monitor screen 20. This authoring software 22 allows the developer to create a graphical element 26 (FIG. 3) that is combined with animated objects, in this case an automotive vehicle, and music, or videos, to allow the user to interact with the advertisement, and consequently, have a more satisfying experience when viewing an advertiser's web site 28. This invention will be discussed in terms of advertising an automotive vehicle, but other objects could be advertised using this invention. Nevertheless, the systems and methods of this invention are especially advantageous in advertising automotive vehicles. Separate movies are created for each model of the vehicle being advertised using this invention.

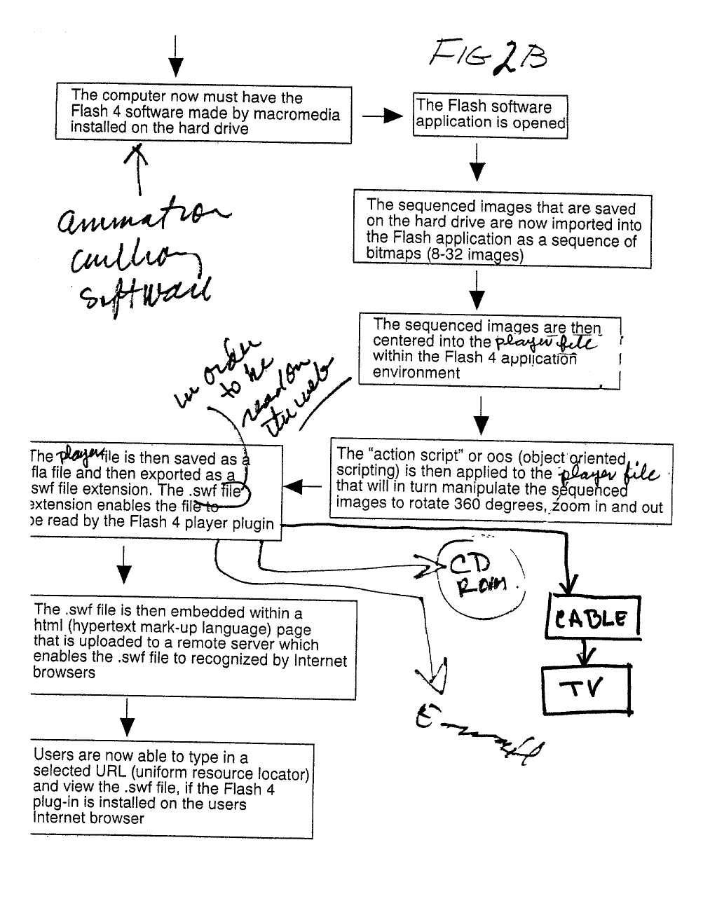

As illustrated in FIGS. 2A and 2B, the object to be advertised, the automotive vehicle, for example, a Mercedes Benz, first has a number of still photographs taken of it in sequence so that when these photographs are displayed in sequence quickly one after another, the object appears to be rotating. The camera taking the photographs may be moved around the object, or, preferably, the camera may be in a stationary position and the object rotated. Preferably, the automotive vehicle is placed on a turntable which rotates, and a series of individual snapshots, preferably using a stationary digital camera, are taken of the vehicle as it rotates step by step in sequence through 360 degrees. Typically, from 8 to 32 individual sequenced images are captured with the digital camera. Each individual image is marked with a number to indicate its sequence and then downloaded from the digital camera to the hard drive 24a of the developer's computer 24. In some instance, it may be desirable to employ an object ring to take a series of photographs on an object, because the angle of rotation maybe adjusted in pitch, yaw, and roll directions.

In accordance with an important feature of this invention, the digital photographs are edited using an image editing program 23 such as Photoshop 5.5 sold by Adobe Systems, Inc. of San Jose, Calif. The editing program 23 is installed in the hard drive 24a of the developer's computer 24, and the sequenced images are inputed into this image editing program as a series of individual images. Then the developer edits these images in the editing program 23 using the keyboard 24b and mouse 24c to manipulate the images to be edited that appear on the monitor screen 24d of the developer's computer 24. In accordance with this invention, the turntable, or any other background elements, are extracted or removed from the sequenced images through an editing technique provided by the editing program 23. Any blemishes that need fixing, or touch-ups that need to be done, are also accomplished using the editing program 23. These sequenced and marked images are then extracted using what is referred to a s “clipping paths” of the editing program 23, so that the image of the object is completely cut out. In other words, in this example, only the vehicle itself, and none of the background, is used. These extracted images can now be colorized, if desired, using the editing program 23. They are then sized, compressed, and saved as a .jpg or .png image file in the editing program 23.

After being edited, colorized, and appropriately identified as to their order of sequence, the images are imported into the authoring program 22 as a sequence of bitmap images. In accordance with this invention, the graphical element 26 shown in FIG. 3 has a display area 26a that is employed to display the edited images of the vehicle. These edited images have been sized to fit in the display area 26a with the center of each individual image coincident with the center 26b of the display area 26a. The graphical element 26 has been programmed using “Action Script” language or object oriented scripting (o o s) language to allow the user by activating different control elements (to be discussed in greater depth subsequently) to alter or change the images appearing in the display area 26a. The user activates the different control elements using the keyboard 18b or mouse 18c of the user's computer 18. When in the authoring program 22, the player file 16 is saved as a .fla file that allows modification. The player file 16 is exported as a .swf extension file that does not allow any modifications to the player file. The .swf file enables the player file 16 to be read by the user who has the “FLASH 4.0” version or above player plug-in program 28 downloaded to the hard drive 18a of the user's computer 18. The “FLASH 4.0” player plug-in program 28 is available at no charge from Macromedia, Inc. Such a player program 28 may be obtained at www.macromedia.com. For the user to access the player file 16, the user's computer 18 must be connected by an internet connection 32 through a server 30 to the internet 14. Although it is preferred to be able to utilize the player file 16 over the internet 14, this is optional. The player file 16 could also be downloaded to a CD ROM (Read Only Memory) and then this CD ROM could be loaded into the user's computer 18, or the player file could be sent via e-mail using an .exe file to the user, or even transmitted over a cable connection to a digital television.

Assuming the player file 16 is to be employed over the internet 14, then the .swf file is embedded in an .html (hyper-text mark-up language) file that is uploaded through an internet connection 32 to a remote server 30 which enables the .swf file to be recognized by internet browsers. A user having a browser 34 installed on the user's computer hard drive 18a is now able to type in using his or her keyboard 18b, or using his or her mouse 18c, a selected url (uniform resource locator), that is, the web site address (www.advertiser.com), and view the .swf file, provided the user has the “FLASH 4.0” version or above reader player plug-in 28.

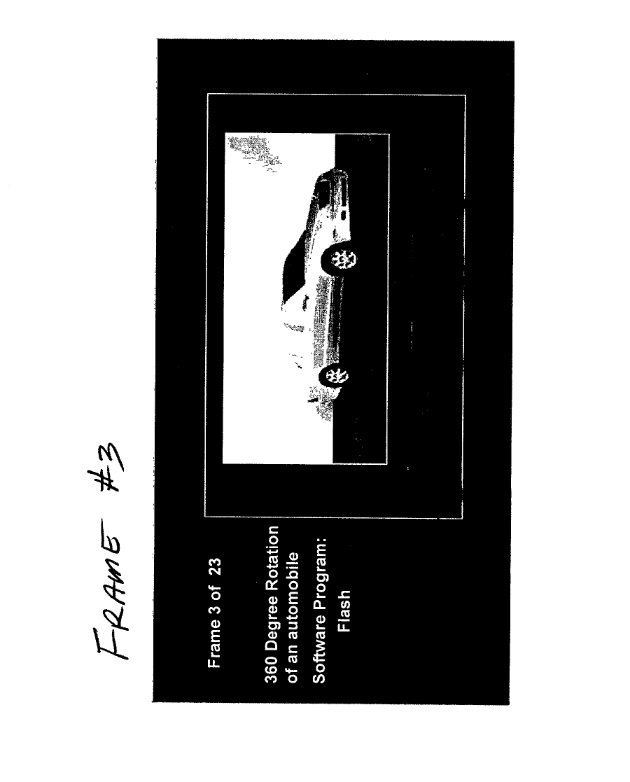

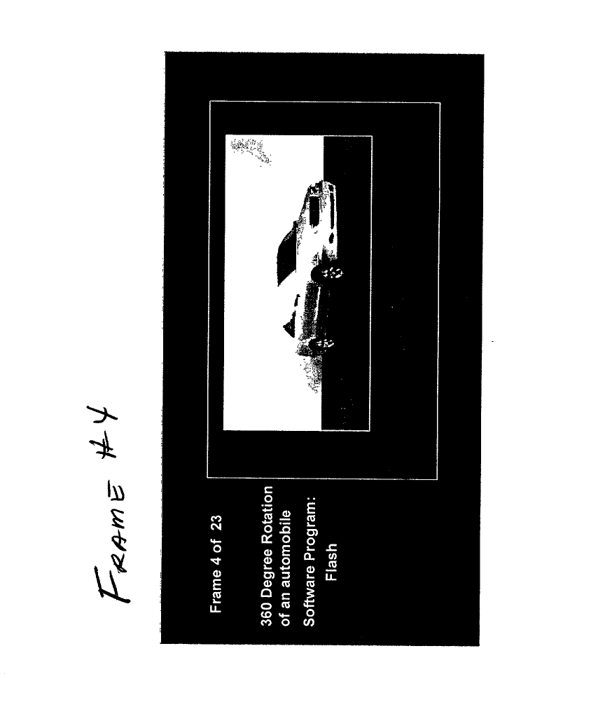

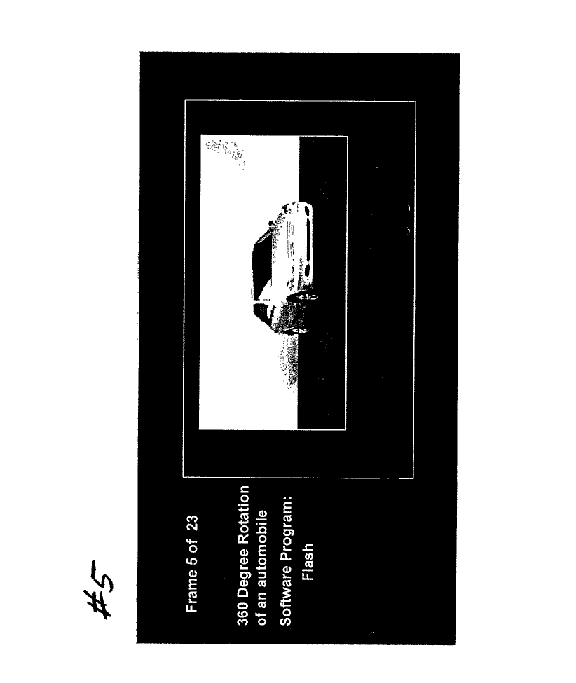

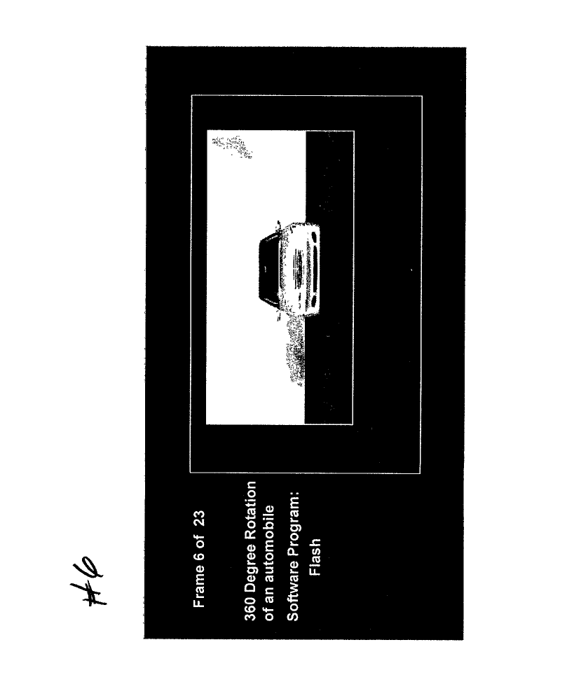

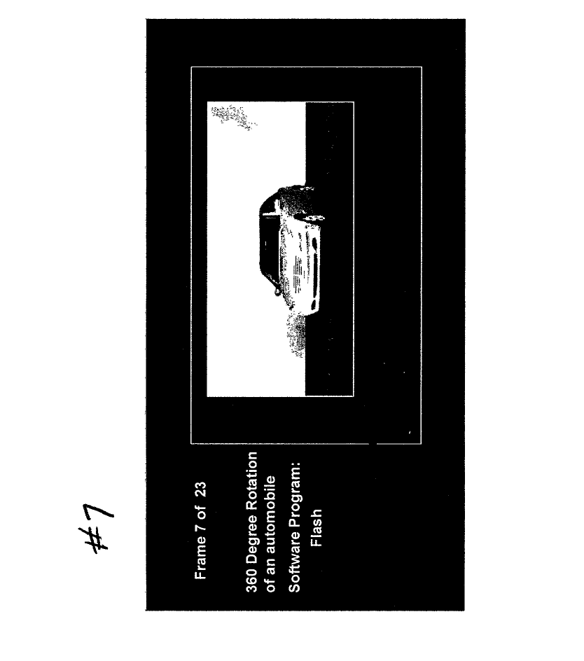

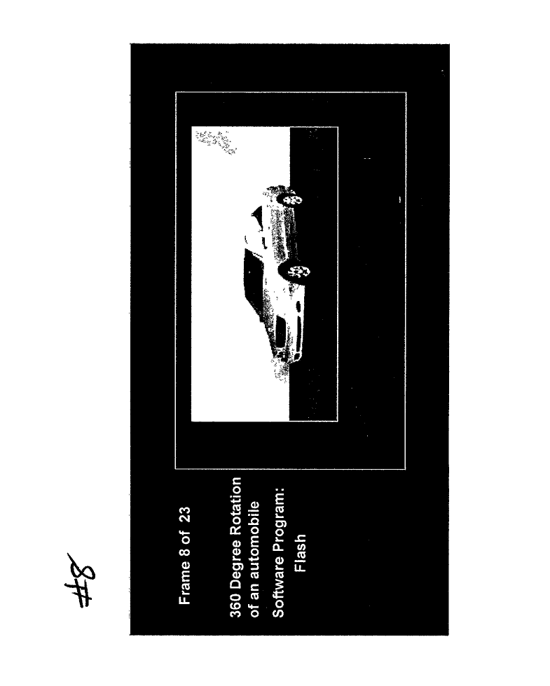

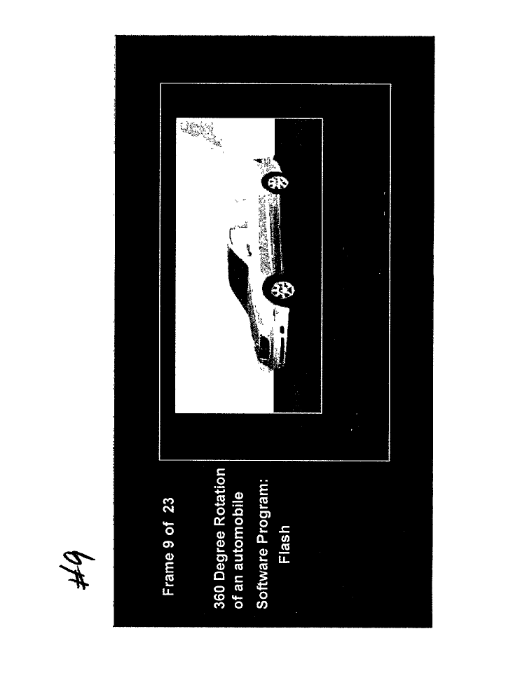

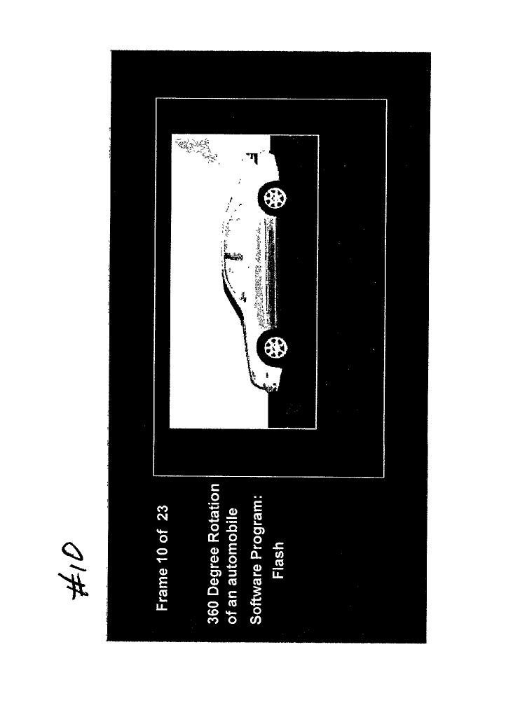

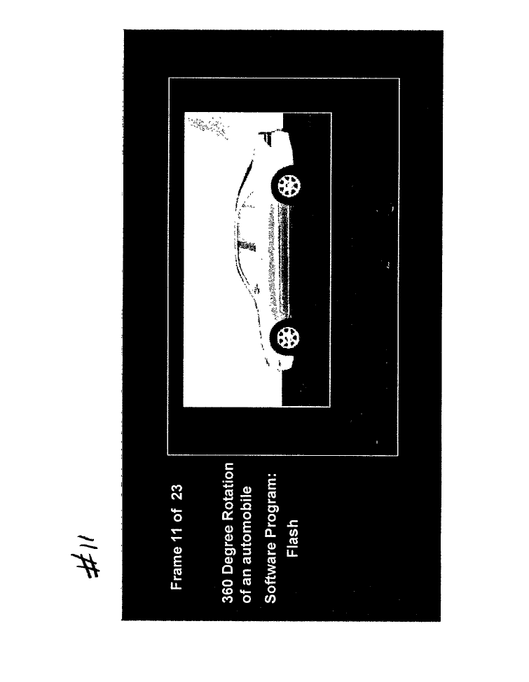

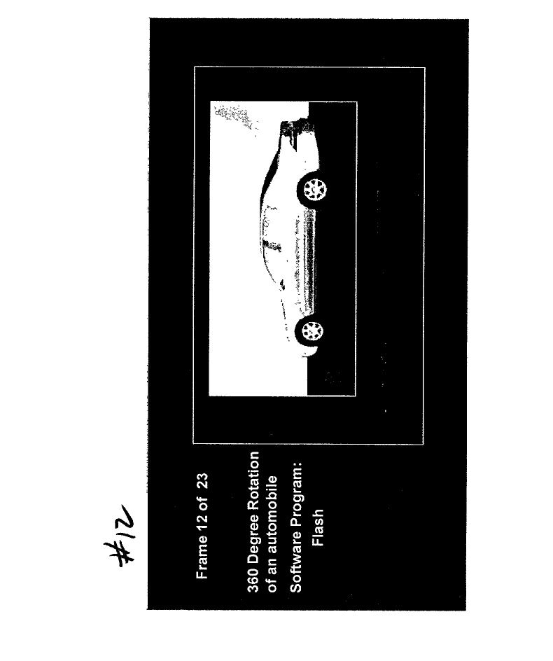

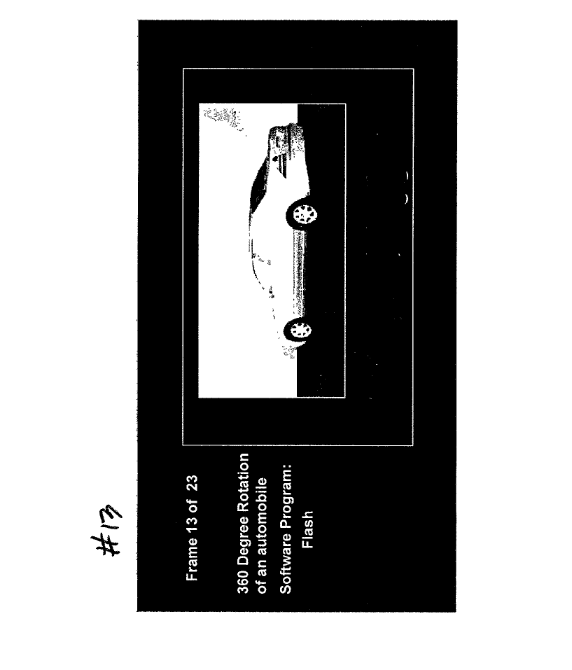

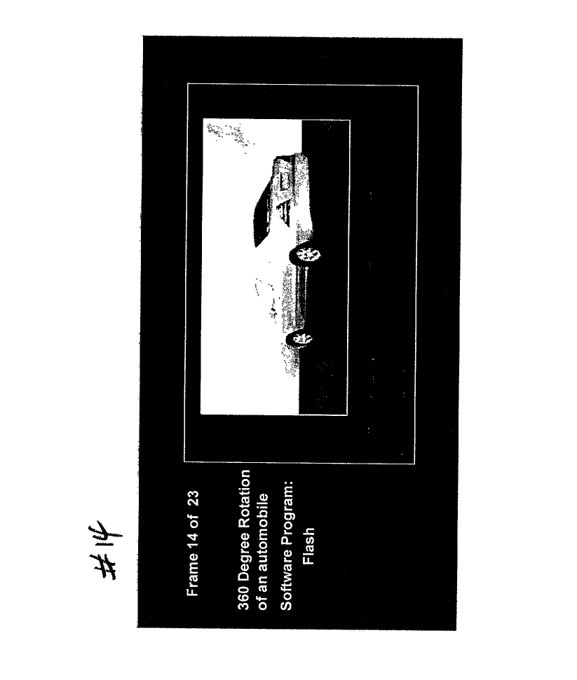

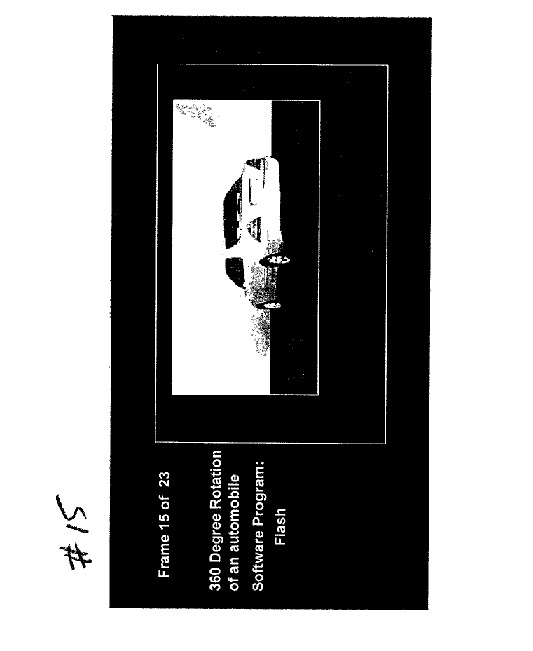

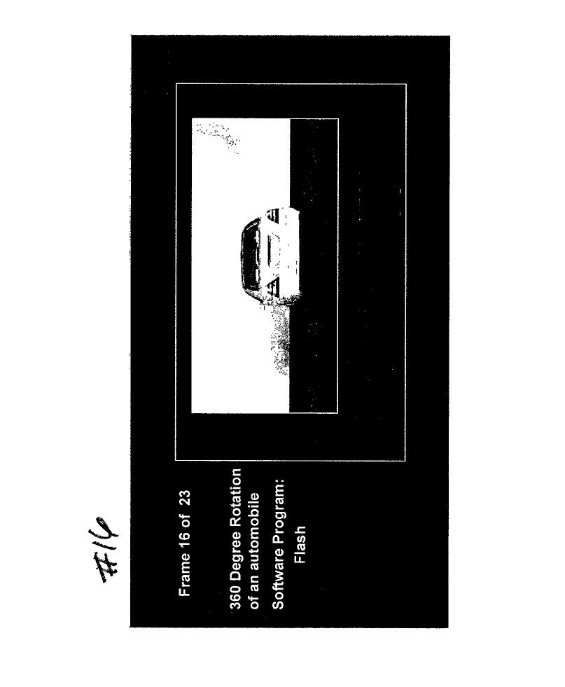

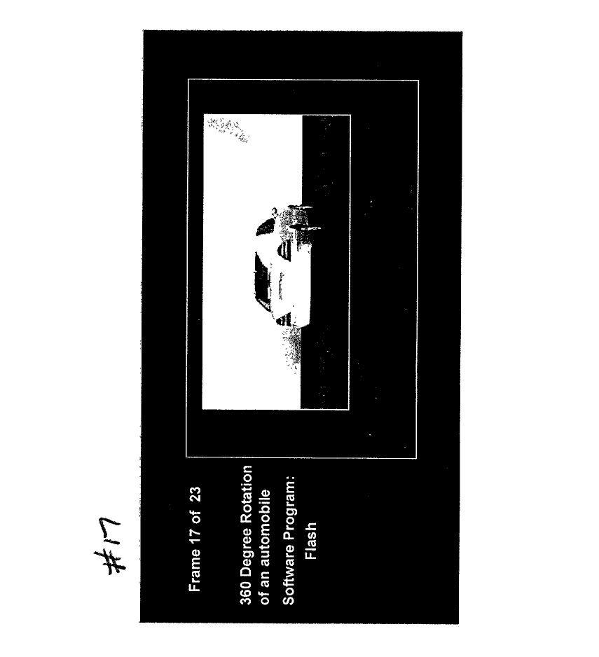

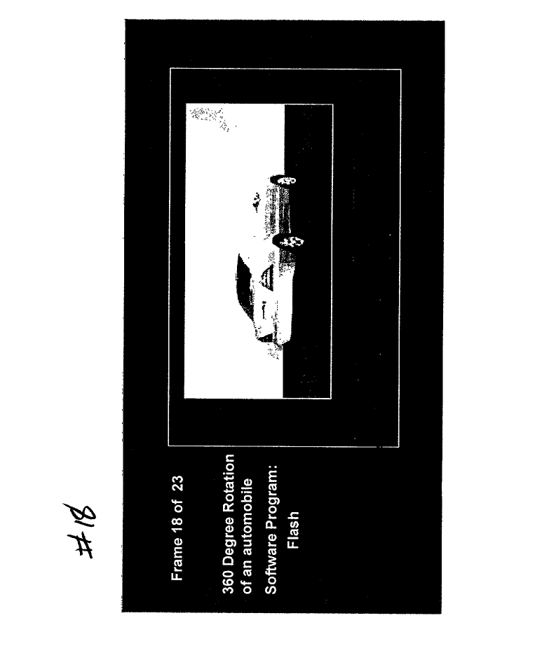

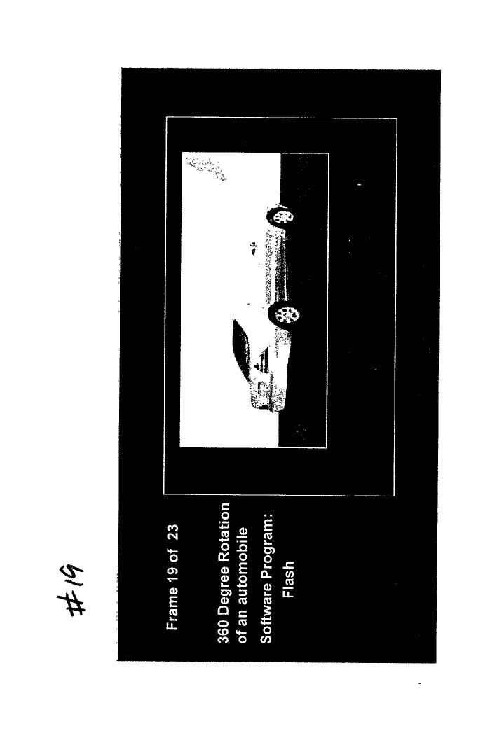

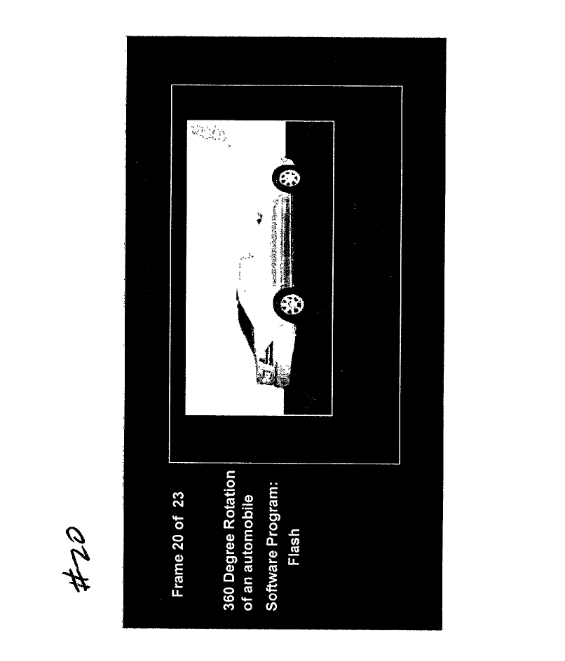

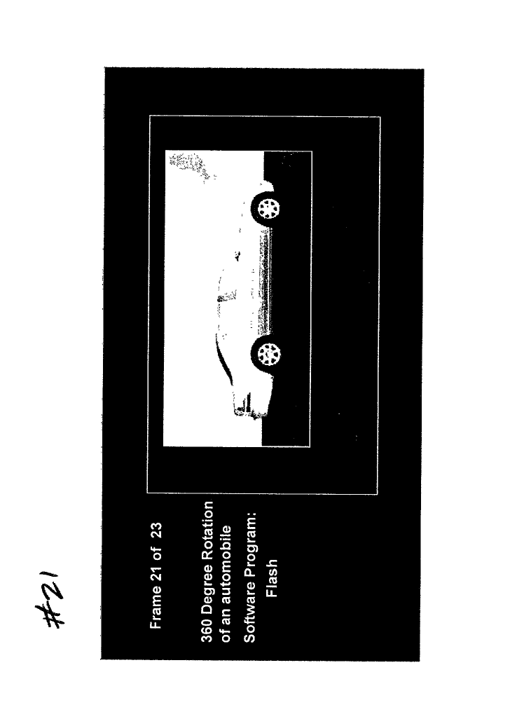

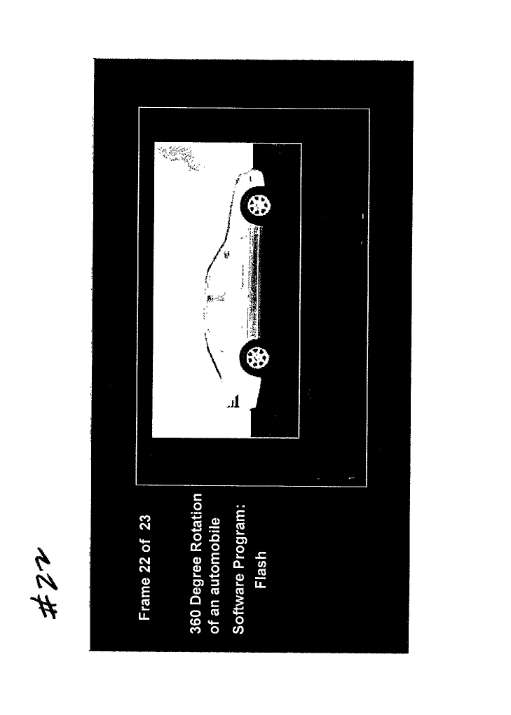

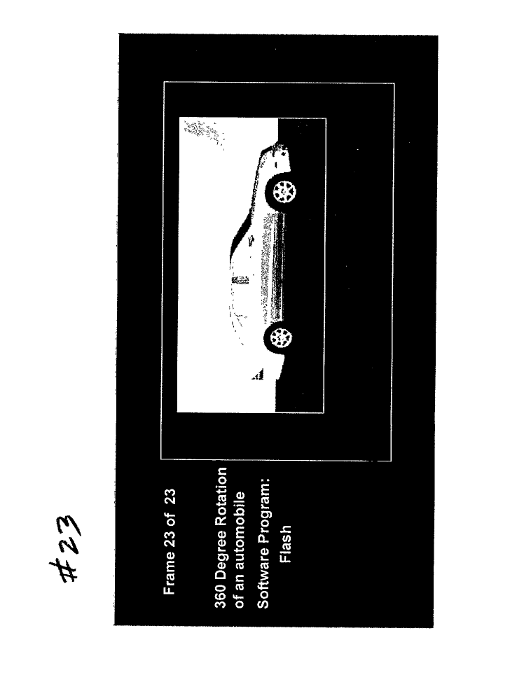

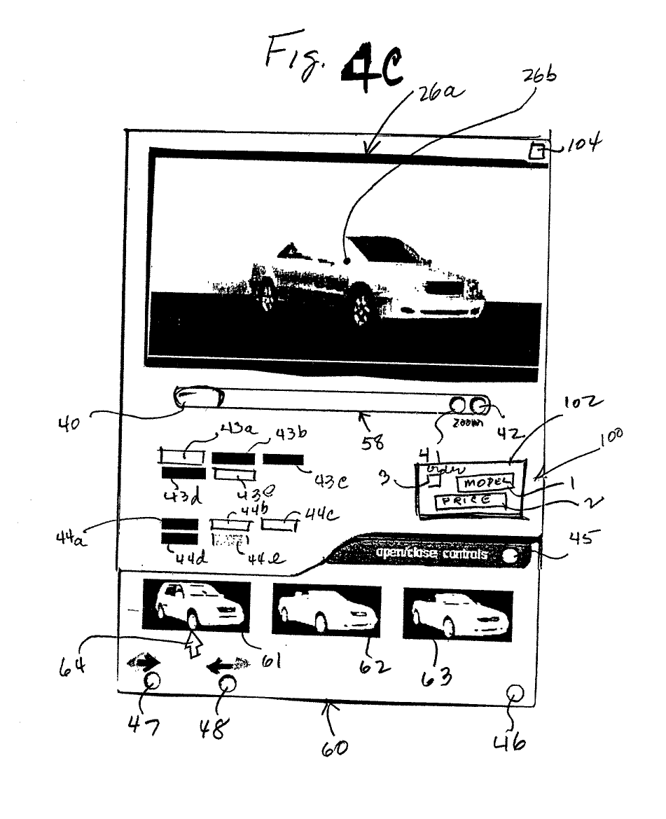

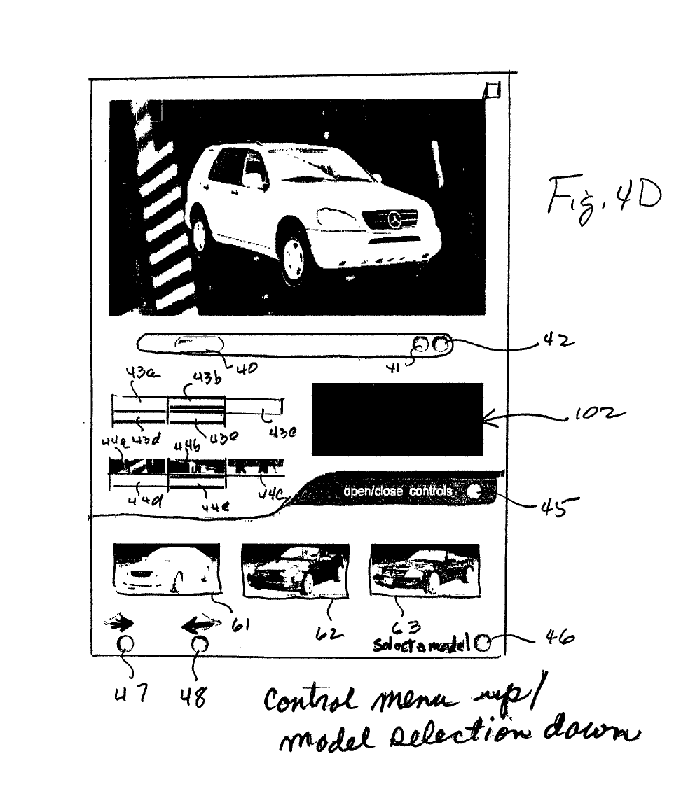

Central to this invention is the creation of the player file 16. This player file 16 is composed of at least two components: (1) a movie 17 (FIG. 4B) of the graphical element 26 having the display area 26a and control elements 40 through 55, and (2) a movie 56 (FIG. 4B) of the automotive vehicle being advertised. The term “movie” as used herein includes both a series of overlaid graphical images, for example, as depicted in FIG. 4A and identified as frame #'s 1 through 4, and a series of individual edited, sequenced photographic images, for example, as depicted in FIG. 4B and identified as frame #'s 1 through 23.

The movie 17 is an overlay of a model drop down menu graphical sub-element 60, a controller drop down menu graphical sub-element 80, and a display graphical sub-element 100. Frame #1 of the movie 17 comprises the graphical sub-element 60, including the graphically composed control buttons 46, 47, and 48 and three aligned rectangular window screens 61, 62, and 63. Different vehicle models are moved into and out of the rectangular window screens 61, 62, and 63 upon the user first activating the drop down command button 46 and then activating either the forward command button 47 or the reverse command button 48. These buttons are activated using the mouse 18c of the user's computer 18. For example, as illustrated in FIG. 4C, the user has activated the drop down command button 46 by clicking on this button using the mouse 18c to lower the graphical sub-element 60. Using the mouse 18c, the user moves the pointer 64 over the image appearing in window screen 61 and clicks the mouse, causing the same image appearing in window screen 61 to appear in the display area 26a. The user simply makes a change in the model to be viewed by activating either the forward command button 47 or the reverse command button 48 using the mouse 18c to click on either of these buttons. The images of different models then move into the window screens 61, 62, and 63 as illustrated in FIG. 4D. When finished, the user simply again clicks on the drop down command button 46 and the graphical sub-element 60 returns to its raised position as shown in FIG. 3.

Frame # 2 of the movie 17 comprises the controller graphical sub-element 80 that enables the user run the movie 56 and select one of three different music tracks while the movie is running. After first activating the open/close button 45 by moving the pointer 64 over this button and clicking on this button with the mouse 18c, the controller graphical sub-element 80 is moved from a raised position as shown in FIG. 3 to the lowered position shown in FIG. 4E. The user may now activate one of the three control buttons 53, 54, and 55 by moving the pointer 64 over a selected button 53, 54, or 55 and clicking. The movie 56 being displayed in the display area 26a is played using the mouse 18a and clicking to activate the play button 51, stopped by activating the stop button 50, fast forwarded by activating the fast forward button 52, or reversed by activating the reverse button 49.

Frame # 3 of the movie 17 comprises the display graphical sub-element 100. In addition to the display area 26a, there is an advertiser information window 102 in which is displayed information about the advertiser such as address, telephone number, fax number, e-mail address, or other data. This advertiser information window 102 may also be used as an e-commerce site to conduct transactions such as purchasing the vehicle being displayed in the display area 26a. This window as shown in FIG. 4C displays an area 1 that indicates the selected model to be order, the an area 2 that indicates the price of the model to be order, and a box area 3 that is clicked with the pointer 64 to place the order.

As shown in FIGS. 3, 3A and 4A, the display graphical sub-element 100 includes: (1) a graphically composed slider bar 58 with a slider control button 40; (2) a zoom in control button 41 and a zoom out control button 42 that enable the size of the image in the display area to be increased (FIG. 21) or decreased (FIG. 20); (3) the control buttons 43a through 43e that enable the user to select the color of the vehicle being displayed in the display area 26a; and (4) the control buttons 44 a through 44e that enable the user to select the background of the display area to be changed by activation of one of these different background control buttons. This buttons are activated using the mouse 18c in the conventional manner by pointing the pointer 64 and clicking.

Frame #4 of the movie 17 shows the graphical sub-elements 60, 80, and 100 overlaid to create the graphic element 26 that appears on the user's screen 20 when the player file 16 is opened by pointing and clicking on the open/close box 104. Clicking again on this box 104 closes the player file 16.

The movies 17 and 56 are created in the FLASH authoring software program 22 installed in the hard drive 24a of the developer's computer 24. Movie 17 is created in one movie file and movie 56 is created in a second movie file. As discussed subsequently in greater detail, first the file of the movie 17, the graphical element 26, is downloaded to the user's computer 18, and then the movie 56 is downloaded to the user's computer 18 and displayed in the display area 26a of the graphical element 26. FIG. 4A depicts the sequence, i.e. frames #'s 1, 2, 3, in which the graphical sub-elements 60, 80 and 100 are loaded into the FLASH program. FIG. 4B depicts the sequence, i.e. frames #'s 1, 2, 3 . . . #23, in which the edited images of the automotive vehicle are loaded into the FLASH program.

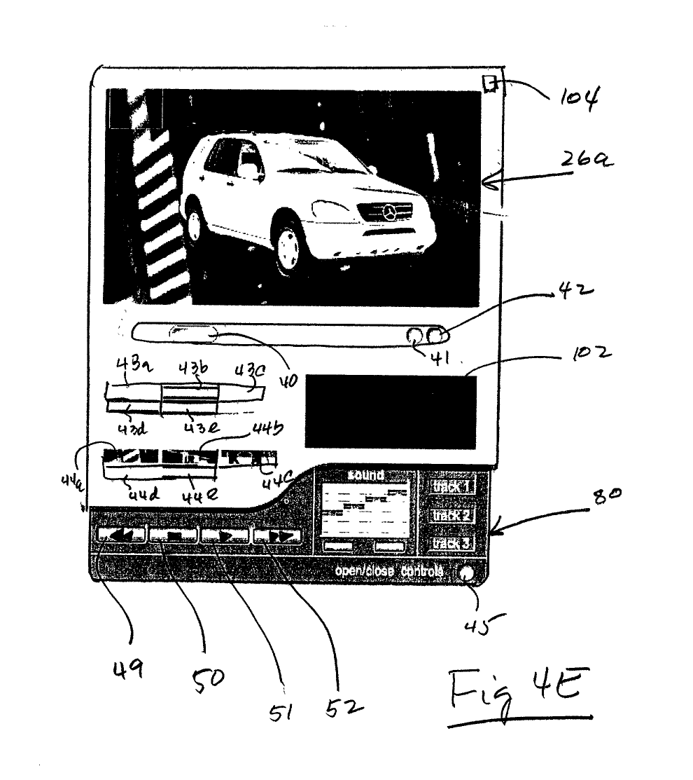

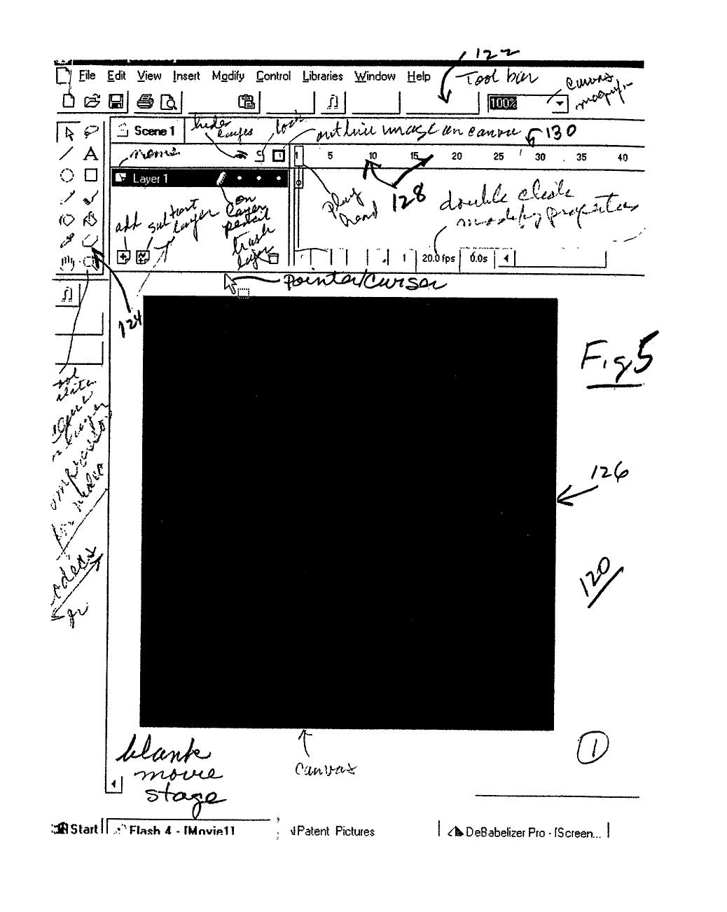

When this authoring program 22 is first opened, a window 120 illustrated in FIG. 5, showing the various operational elements provided, appears on the monitor screen 24d of the developer's computer 24. Along the top of this window 120 is a tool bar 122, along the side is a tool pallet 124, and centrally located is a large square back area that is a composition zone called the stage 126. Initially scene one is to be worked on and this scene will consist of a series of individual images to be loaded into individual frames, called key frames 128, numbered sequentially along what is referred to as a timeline 130. There may also be different constituents of a movie called layers 132 arranged in a column.

In the present example, in one movie file, a layer 132 (FIG. 10) is designated “cars,” and the series of images making up the movie 56 are loaded sequentially into the FLASH program 22 in accordance with conventional techniques, one after another, in the layer 132. In a similar manner, a separate movie file is created where the different images making up the movie 17, the graphical sub-elements 60, 80, and 100 of the graphic element 26, are loaded into this separate movie file.

With the authoring program 22 open, the sequence of images that have been edited using the editing program 23 are imported into the first movie file. As shown in FIG. 6, first the stage properties are set by activating the menu with the pointer 64a by pointing and clicking on the file menu icon 140. The developer clicks his or her mouse 24c and the movie properties menu appears on the developer's screen. Typically, the frame rate will range between 12 and 32. In this example, the frame rate is shown as 15 frames per second. The dimensions of the stage 126 will typically have a width of from 300 to 500 pixels and a height of from 350 to 500 pixels. In this example, the stage dimensions are 400 pixels wide and 515 pixels high. The color of the grid and the background may also be selected.

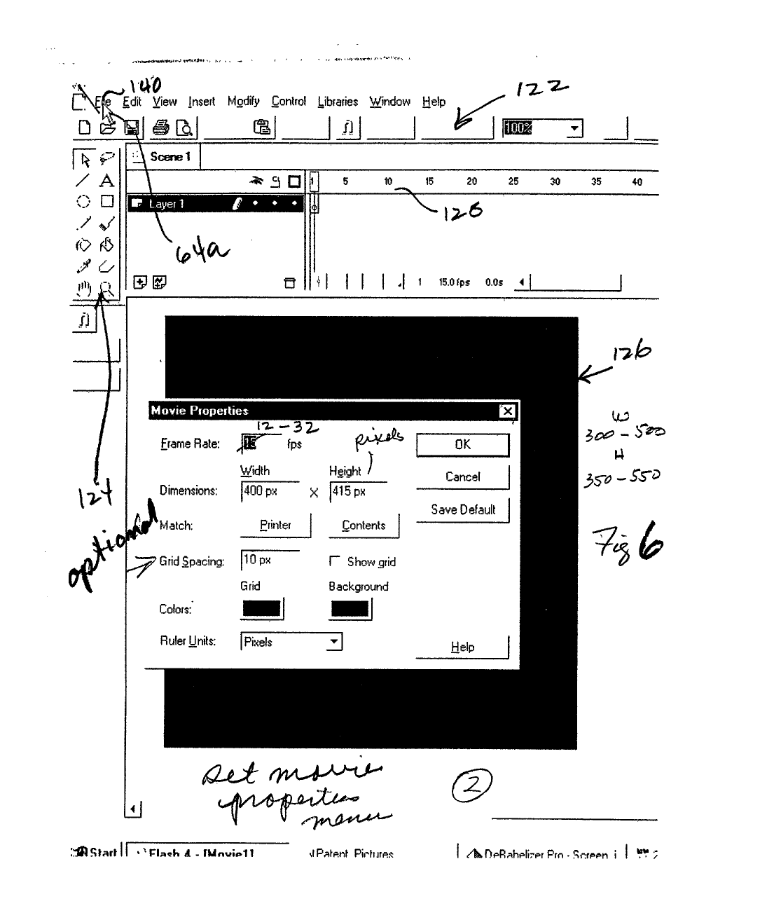

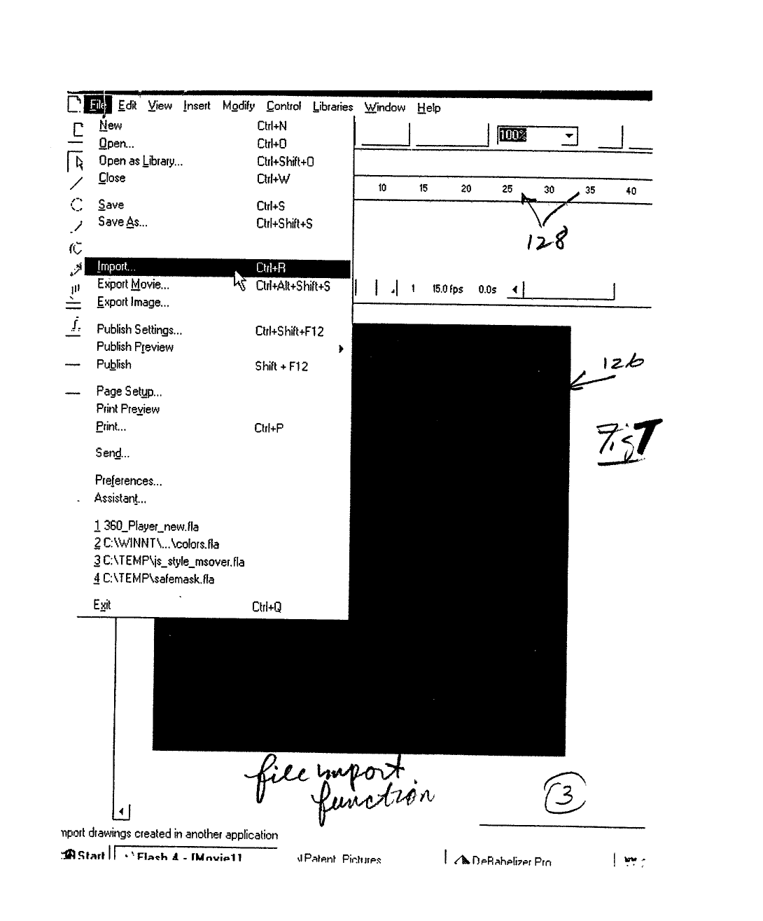

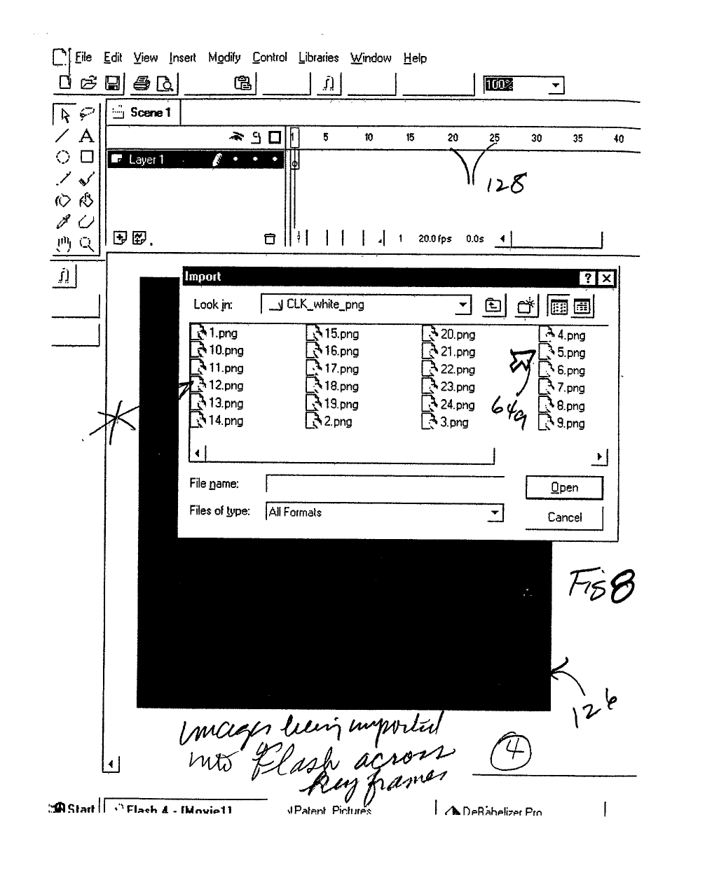

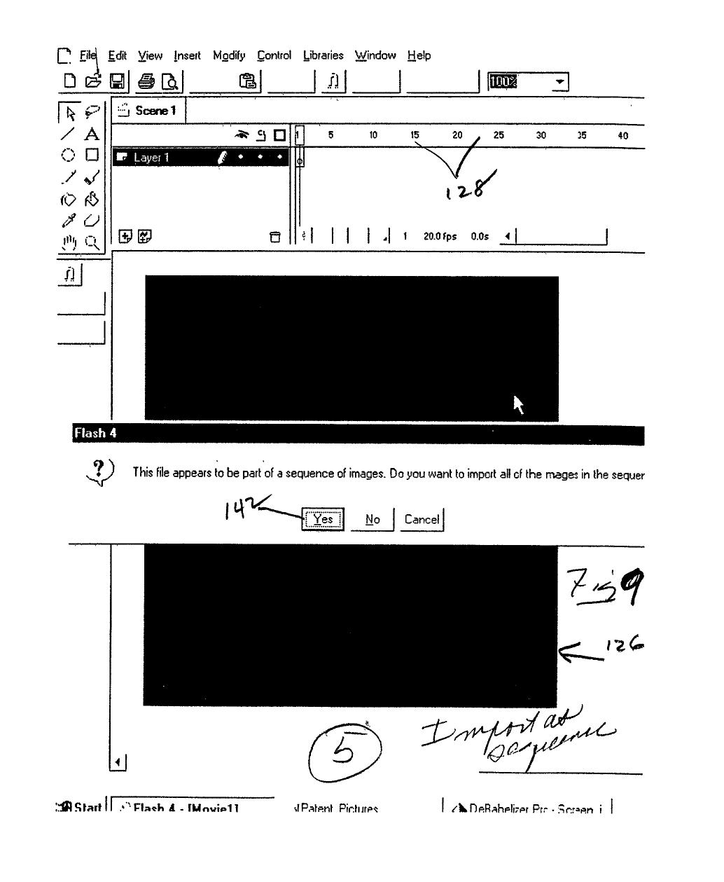

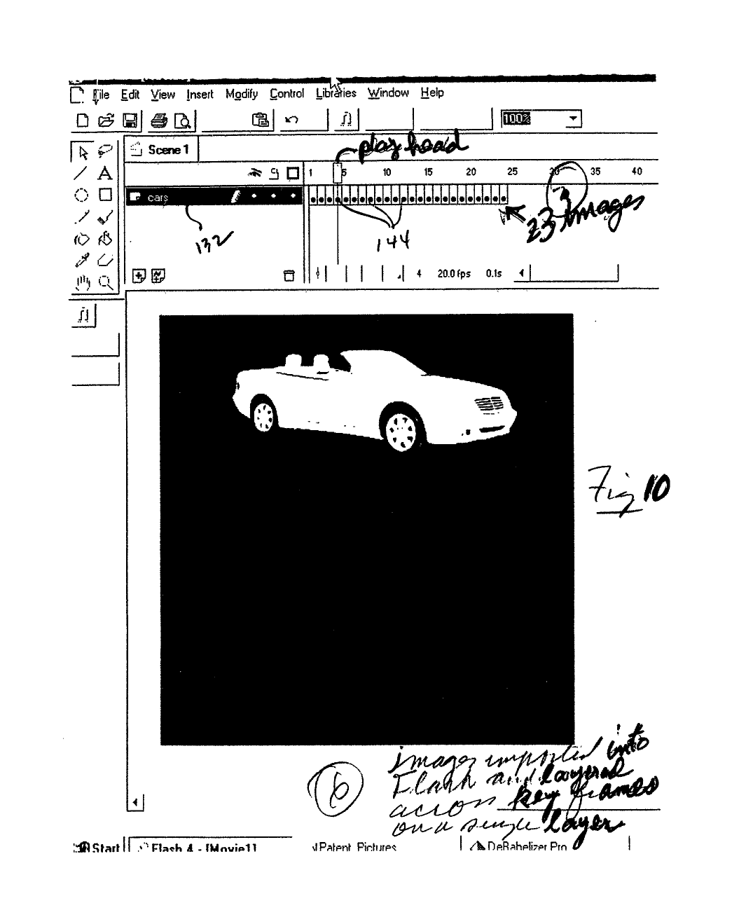

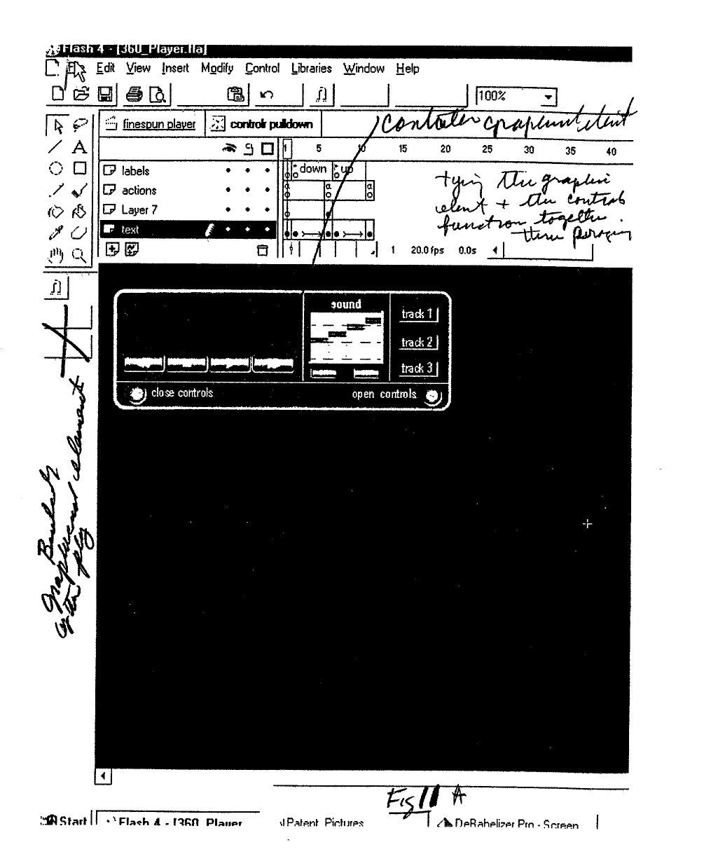

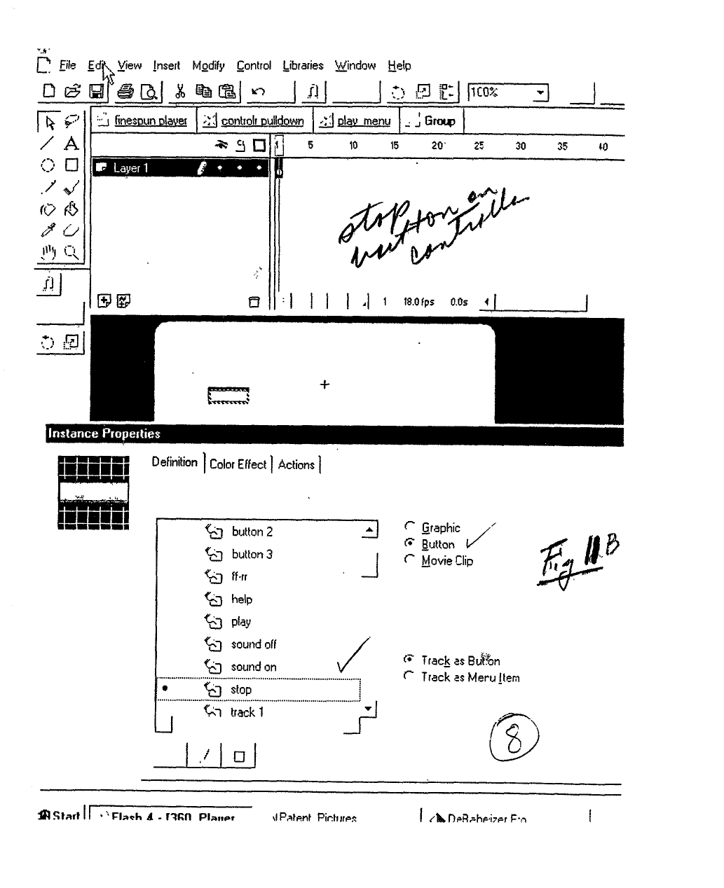

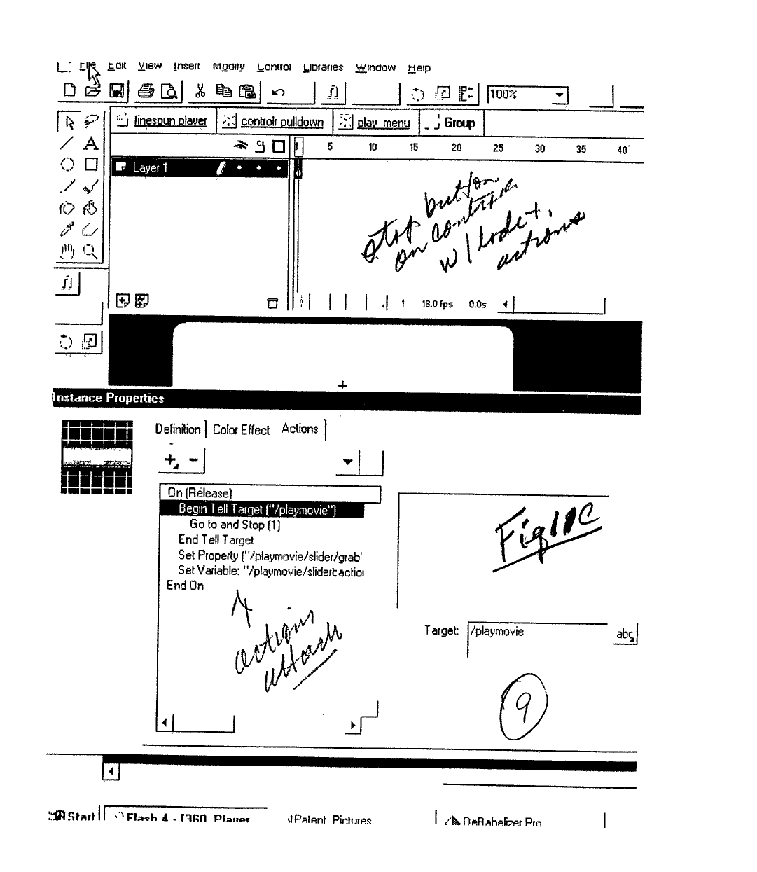

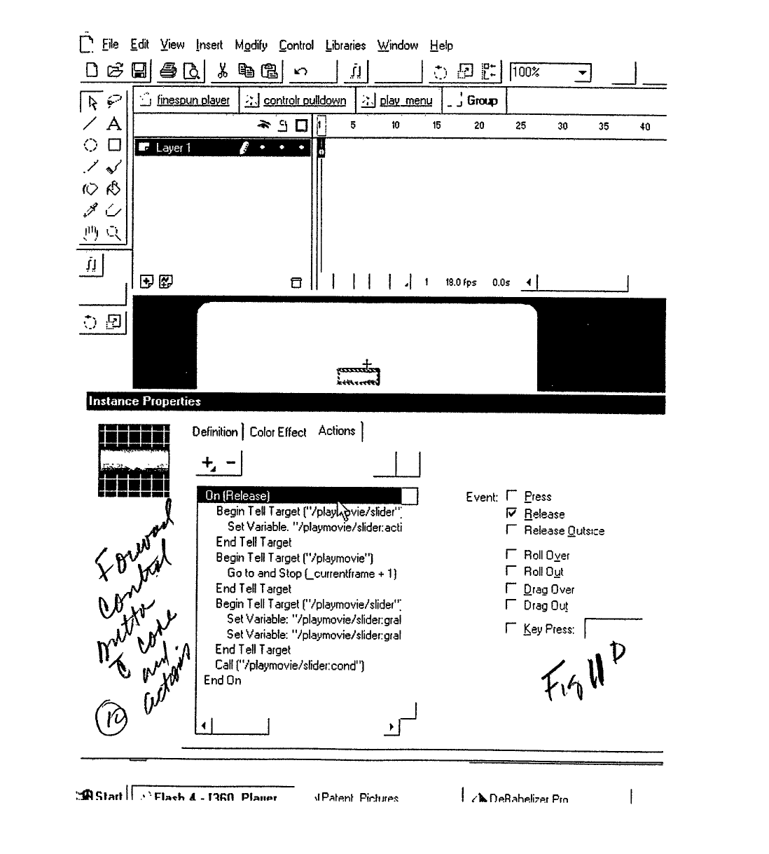

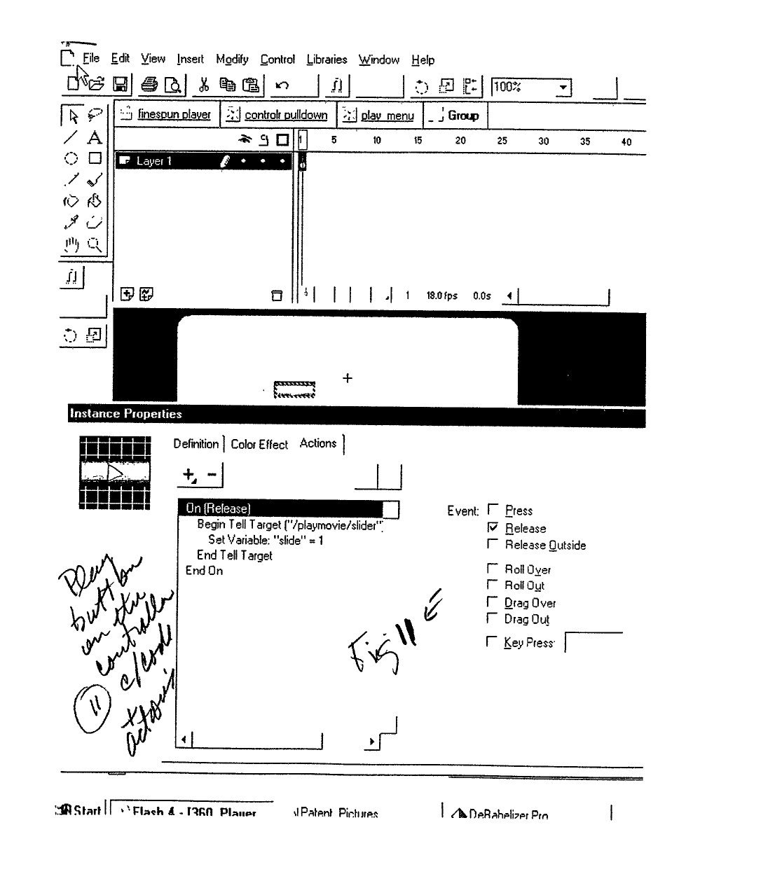

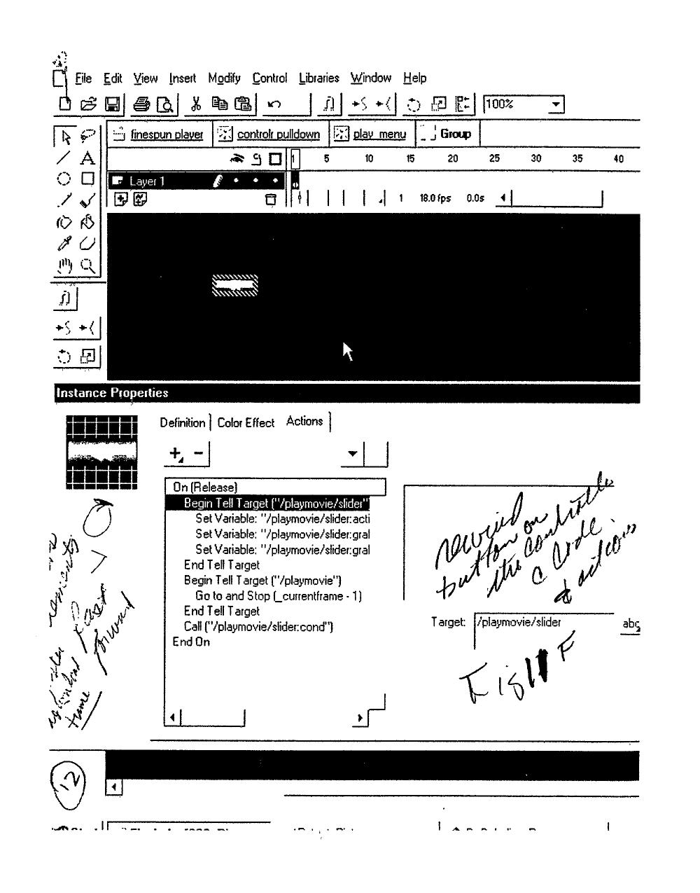

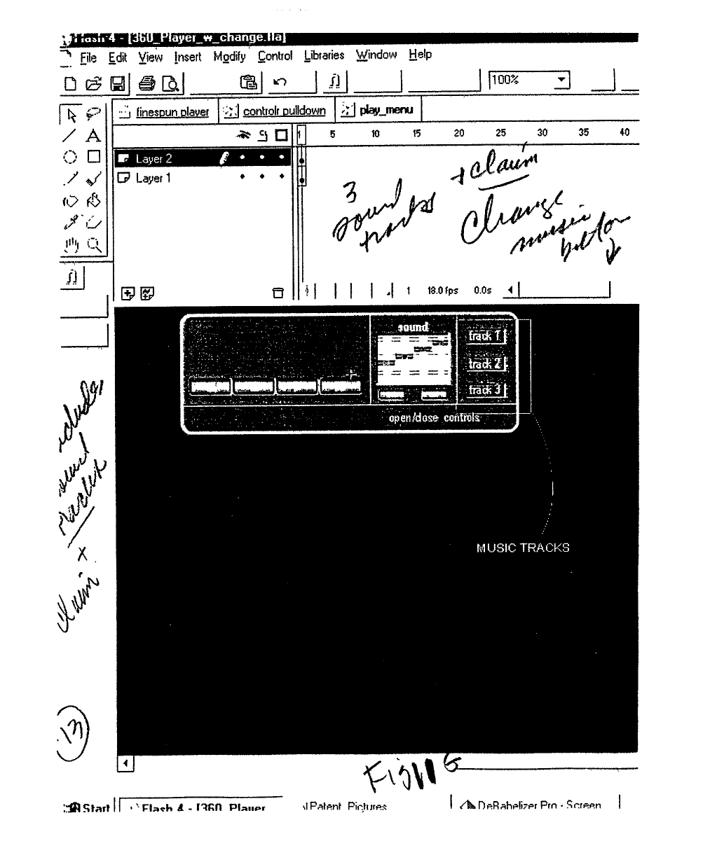

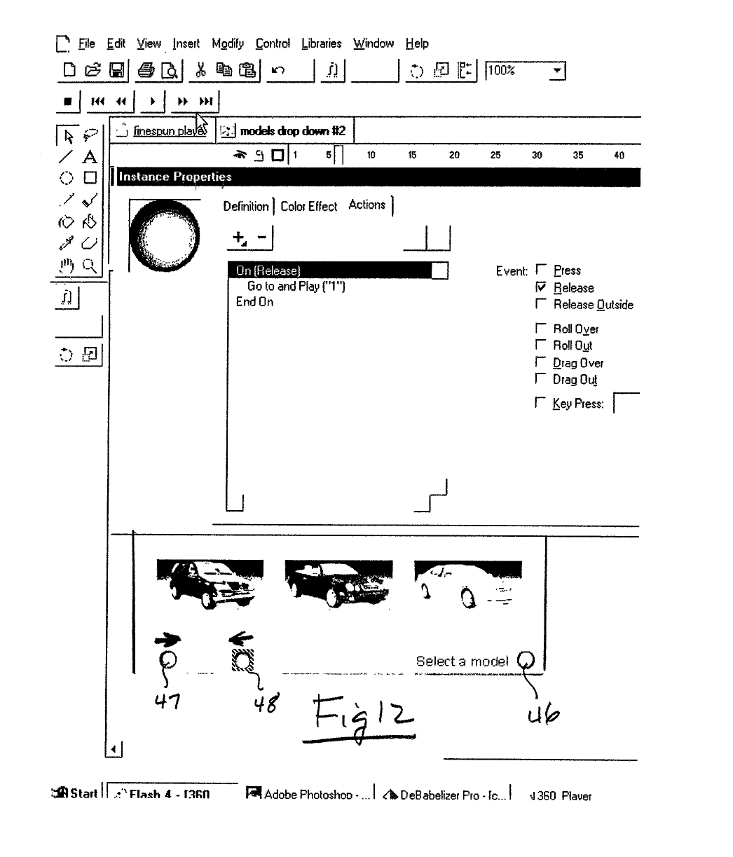

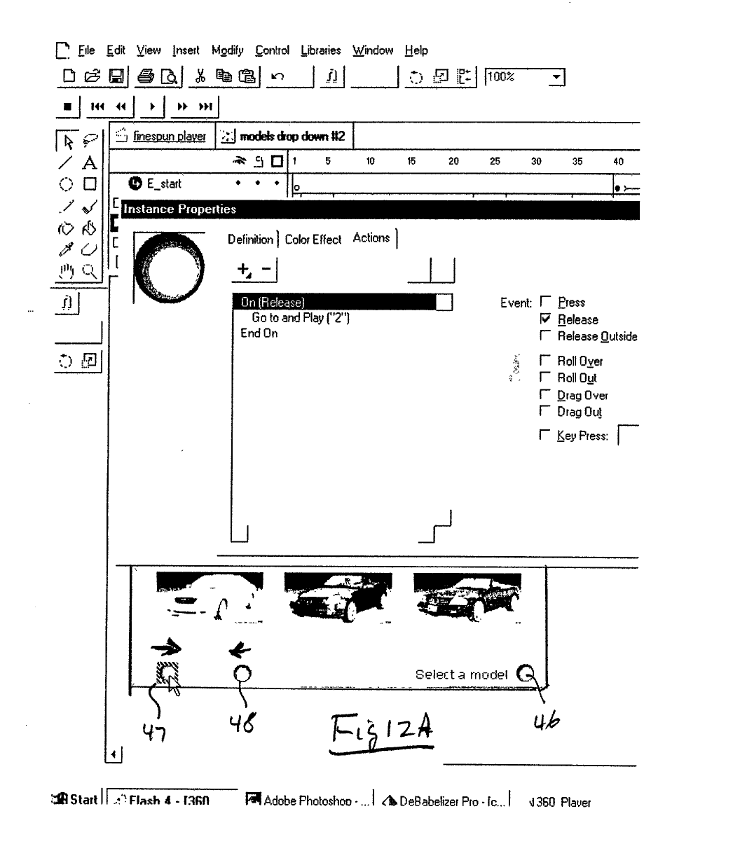

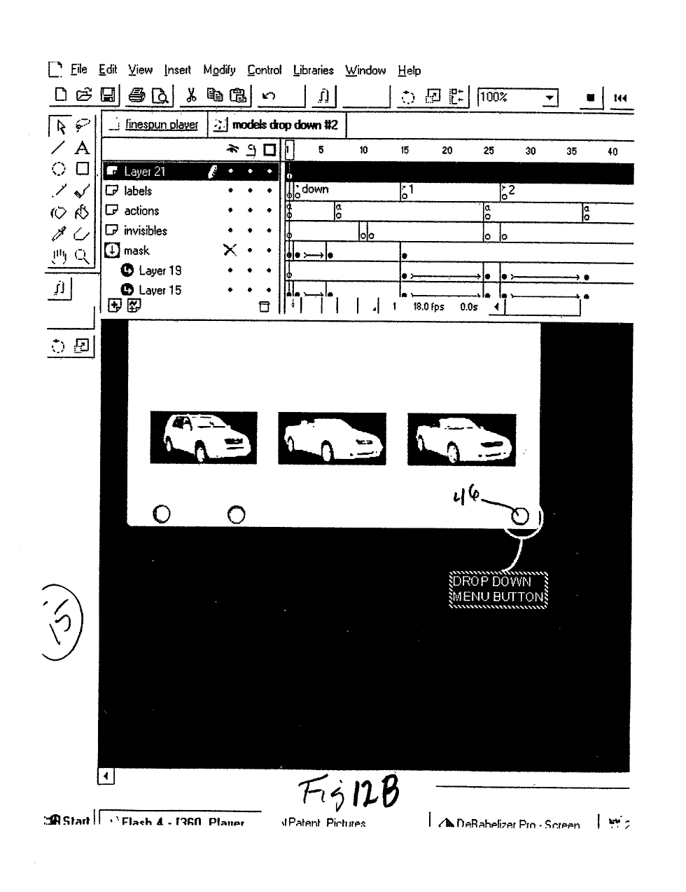

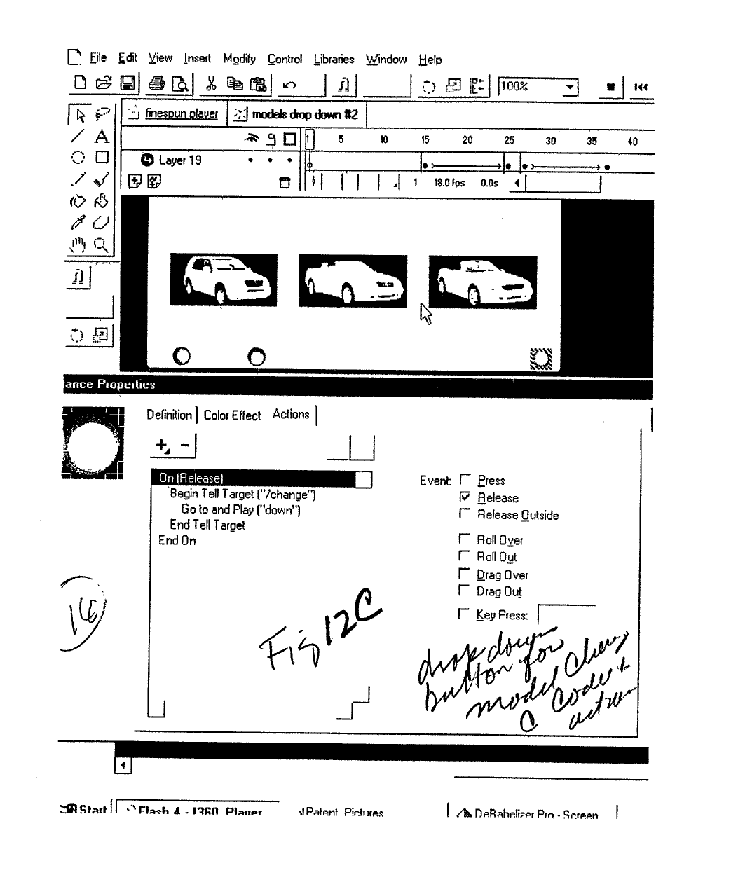

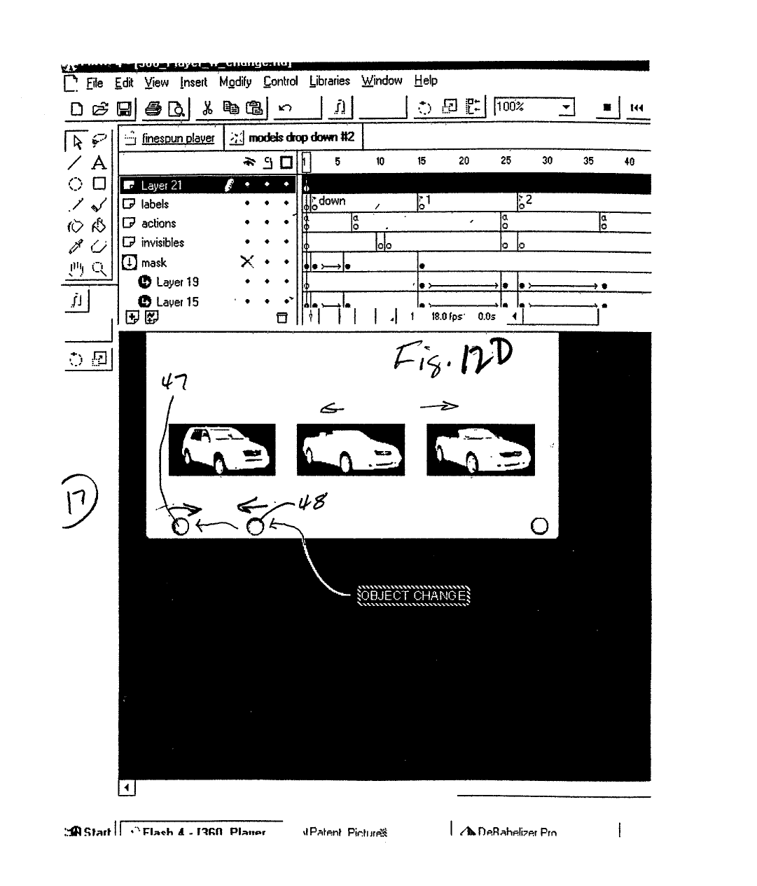

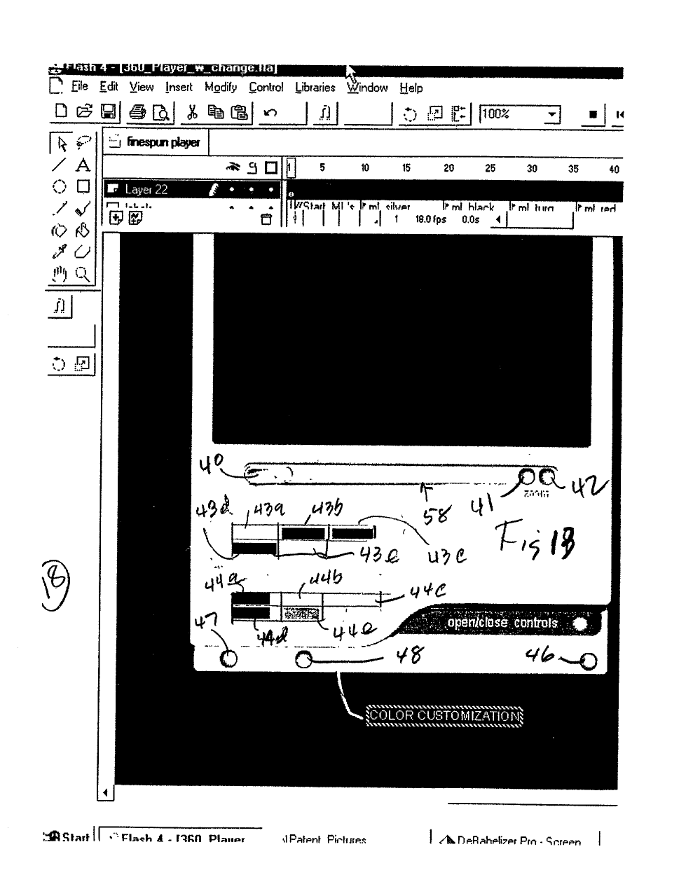

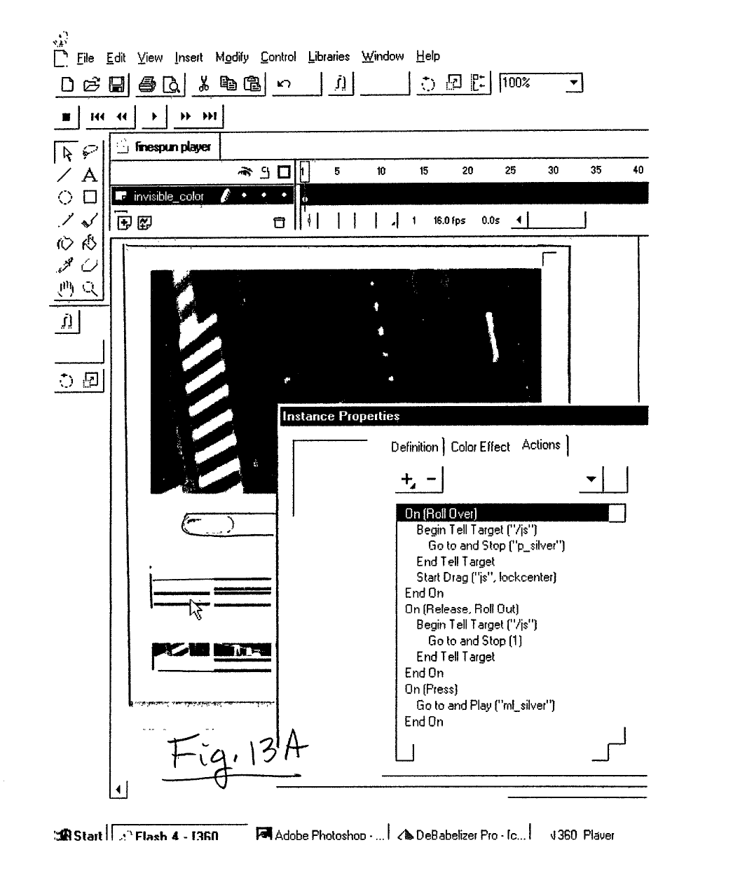

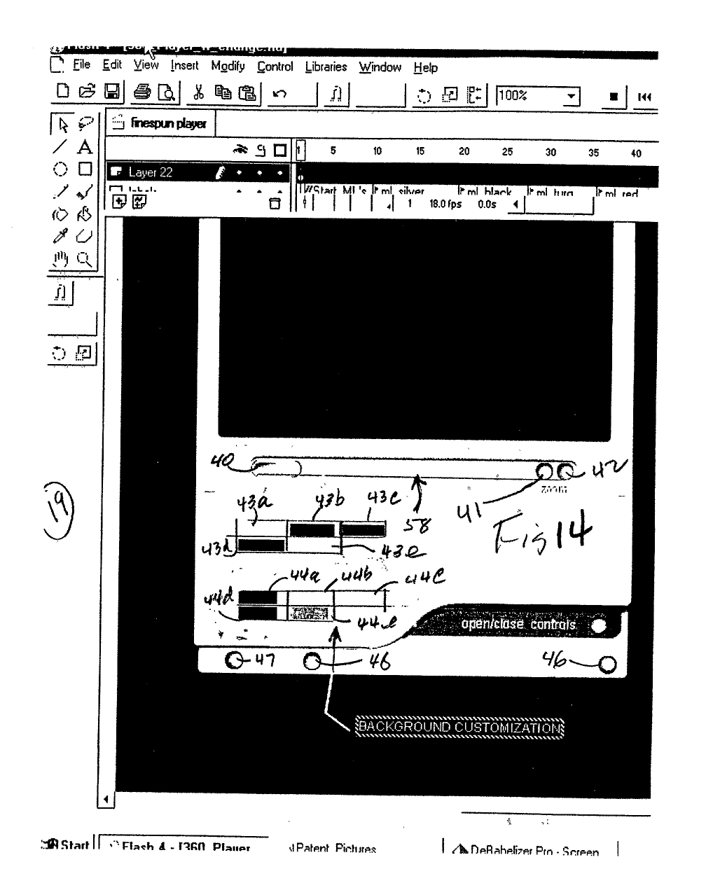

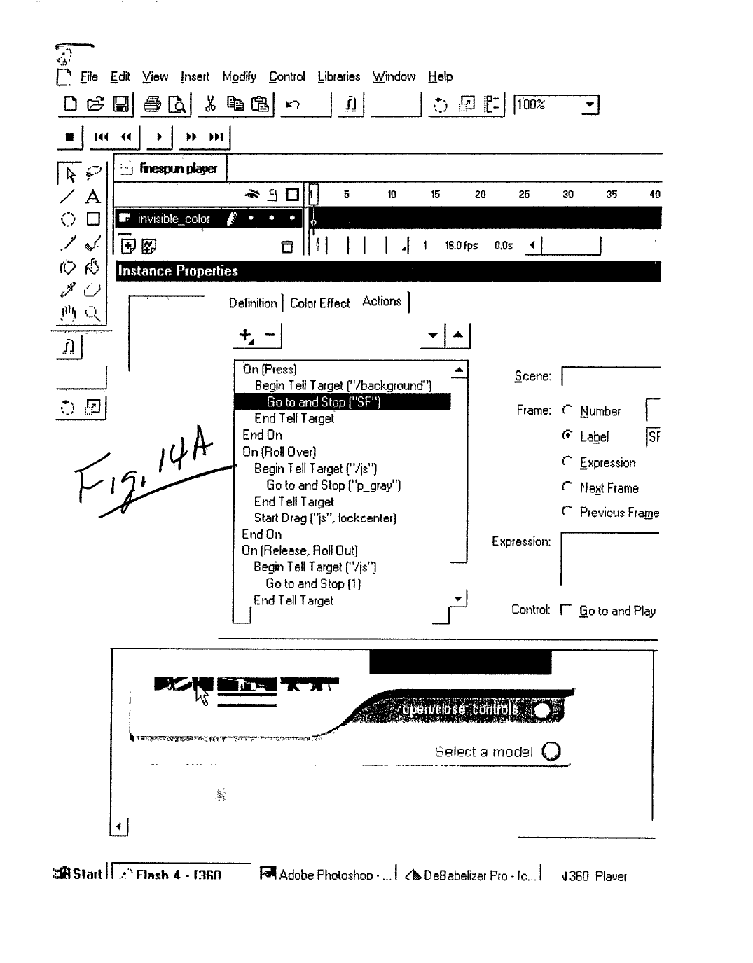

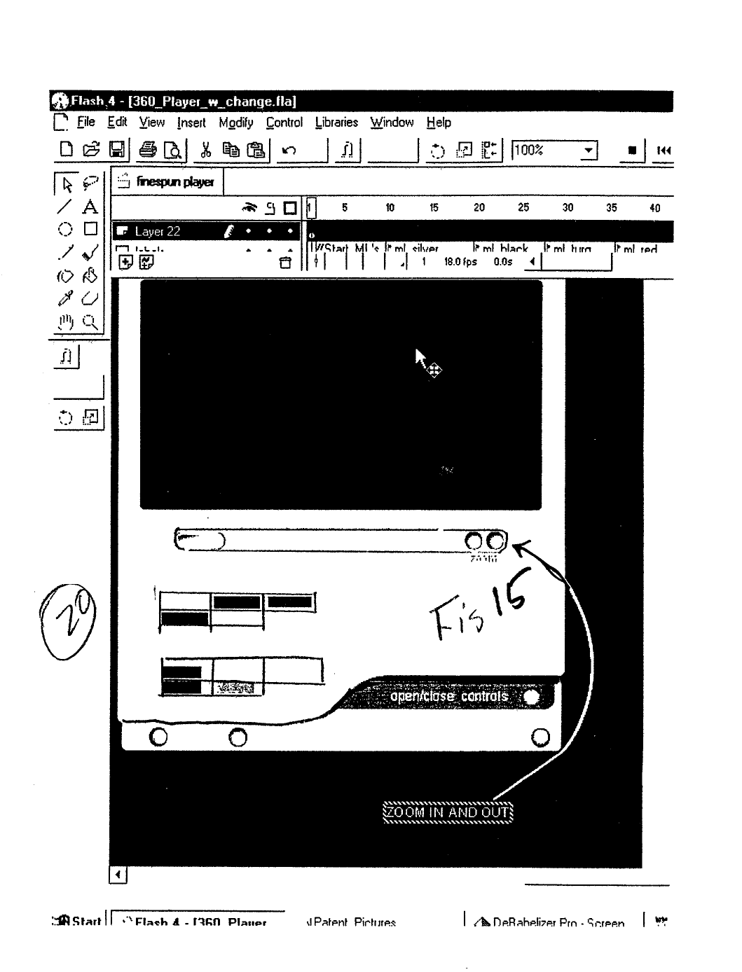

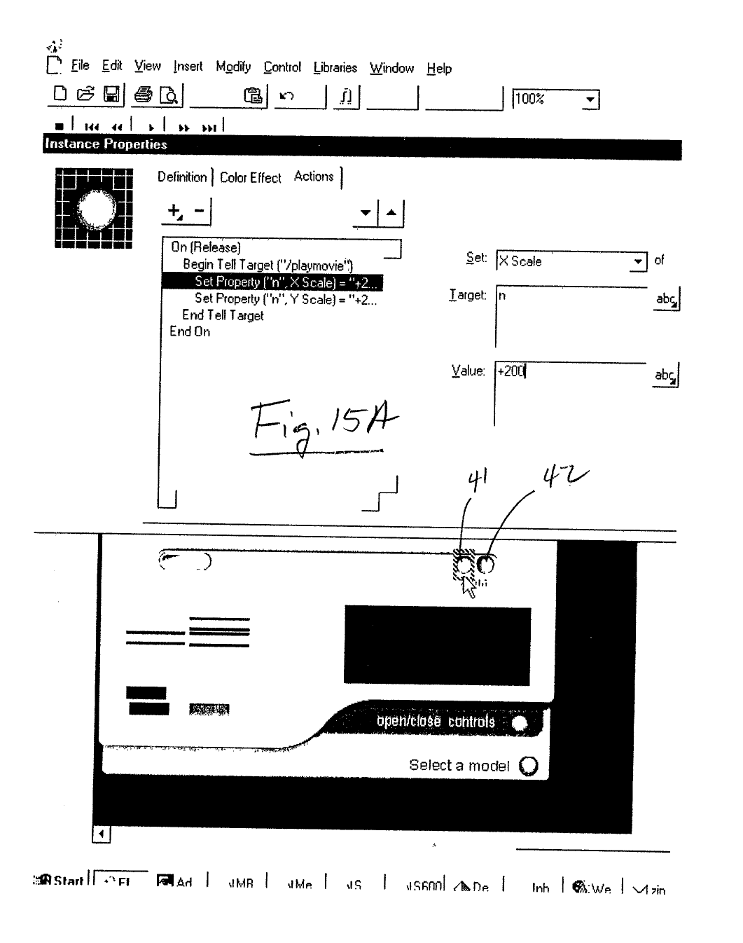

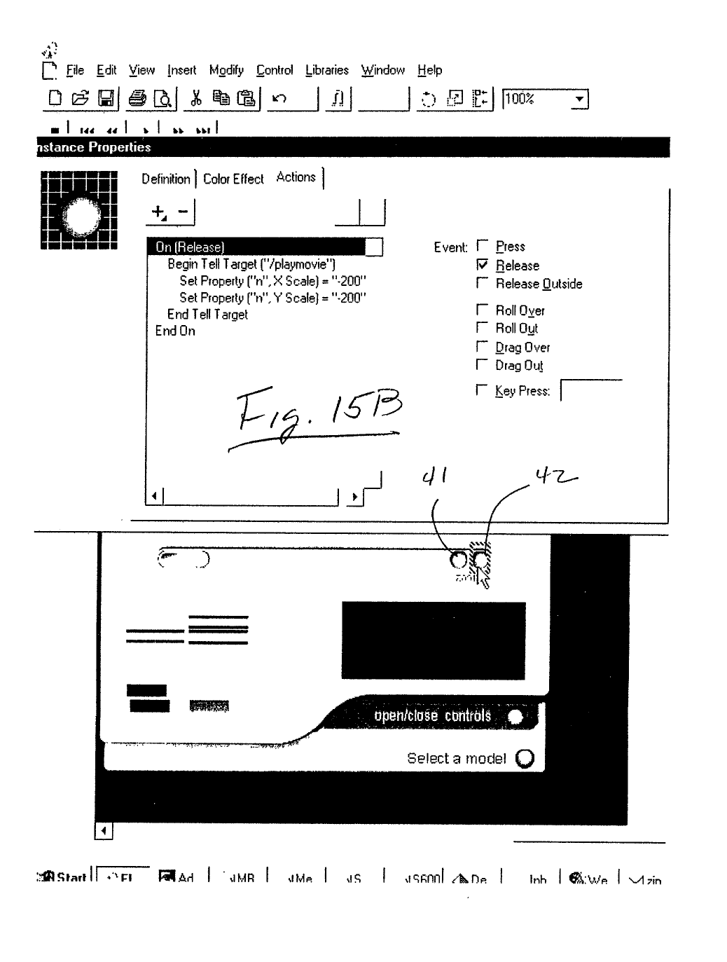

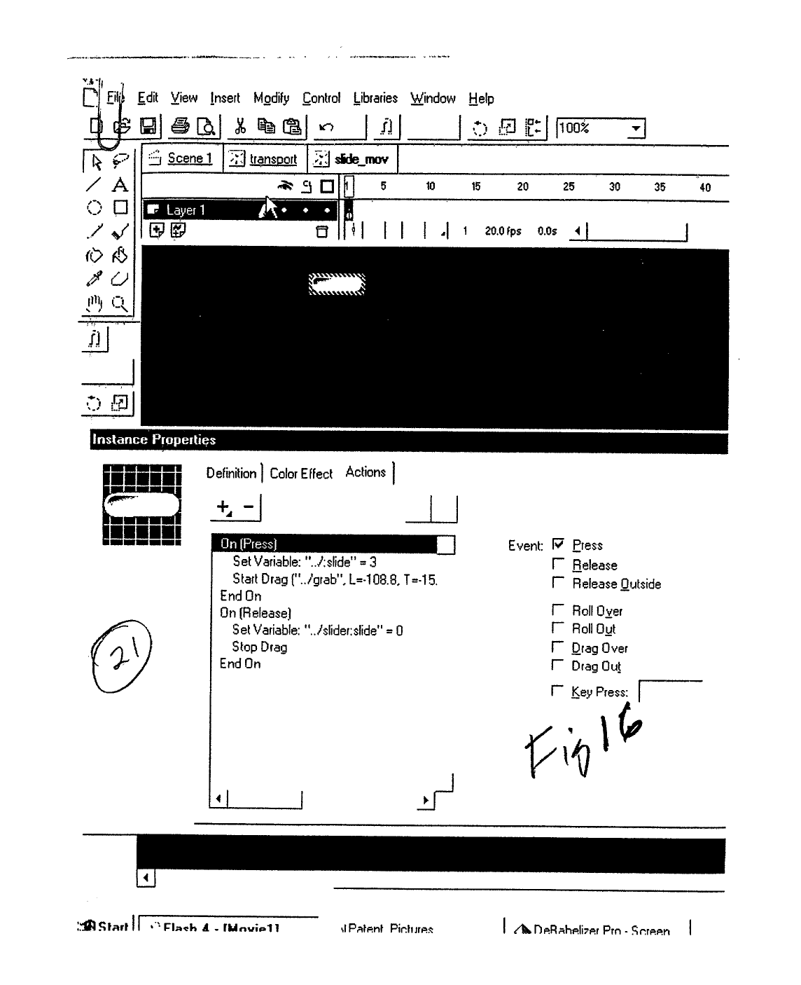

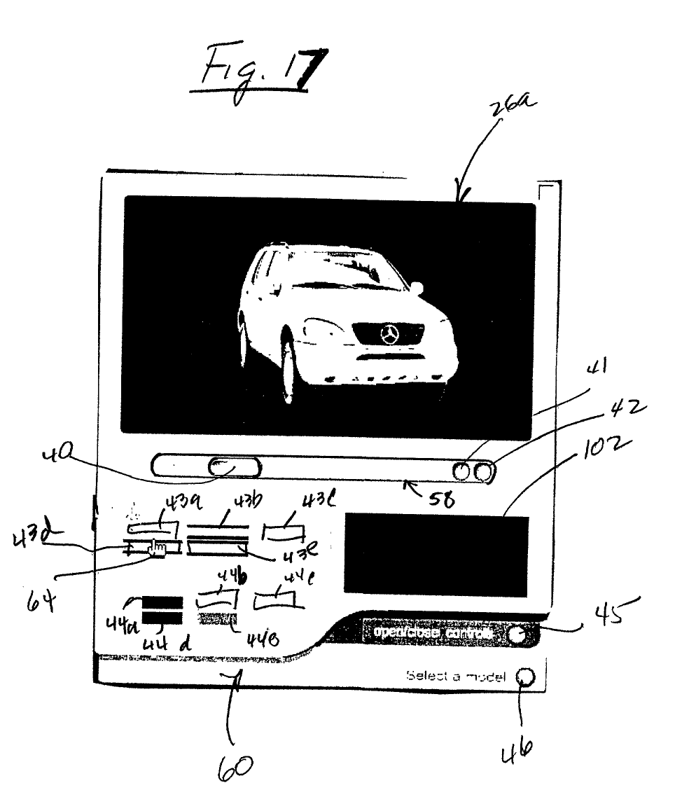

As shown in FIG. 7, the developer, opening the file menu by pointing and clicking on the icon 140, imports the edited, sequenced images of the vehicles developed using the editing software program 23. As provided by the authoring program 22, these images can be imported simultaneously by pointing with the pointer 64a and clicking on one of the images. As shown in FIG. 8, in this example, image No. 5. Then there appears on the developer's screen 24d a prompt to import the sequence images in the selected order by simply activating the “yes” button 142 shown in FIG. 9. As shown in FIG. 10, there now appears solid dots 144 in all the key frames numbered 1-23 to indicated that 23 images were loaded in sequence in the layer 132 identified as cars. The movie 56 of the vehicle has now been created in one FLASH movie file.

The developer also creates in the authoring program 22 in another FLASH movie file the graphical sub-elements 60, 80 and 100 of the graphic element 26 and associated control elements to allow the user to manipulate and select the images appearing in the display area 26a when the player file 16 is opened. It is not, however, important that the movie 56 of the vehicle be created first, it is however desirable that the movie 17 of the graphical element 26 be downloaded to the user's computer prior to downloading the movie 56 of the vehicle.

As shown in FIGS. 11A through 16, the control elements are created in a separate movie file in the authoring program 22. As shown in FIGS. 11A through 11G, the controller graphical sub-element 60 includes the sound tracks 53, 54, and 55 and control elements 45, 49, 50, 51, and 52 discussed above. FIG. 11B shows the graphical composition of the stop button 50, and FIG. 11C shows the code for the program regulating the function of the stop button 50 upon activation. FIG. 11D shows the code for the program regulating the function of the forward control button 52 upon activation. FIG. 11E shows the code for the program regulating the function of the play button 51 upon activation. FIG. 11F shows the code for the program regulating the function of the rewind control button 49 upon activation. The play, stop, forward, and reverse functions for the controller graphical sub-element 60 are all in layer 1 of the one FLASH movie file for the movie 17. As illustrated in FIG. 11G, the soundtrack control buttons 53/55 are created in layer 2.

As illustrated in FIG. 12, the graphical sub-element 60 for the drop-down model menu is displayed on the developer's computer monitor screen 24d. As discussed above, by pushing the buttons 47 or 48, different vehicle models will appear in the window screens 61, 62, and 63. For example, by activating the button 48, the models move into an adjacent window scene to the left one model at a time. Conversely, by pressing the button 47, the models move one model at a time to the left as illustrated in FIG. 12A. In this example, there are at least six different models that move in and out of these window screens 61, 62, and 63 in sequence depending on which button 47 or 48 is activated.

FIG. 12B shows the open window of the authoring program 22 during composition of the button drop down command 46. FIG. 12C shows the code for the program regulating the function of the drop down command button 46 upon activation. FIG. 12D shows the open window of the authoring program 22 during composition of the forward and reverse direction buttons 47 and 48. FIG. 12 also shows the code for the program regulating the function of the reverse command button 48 upon activation, and FIG. 12A shows the code for the program regulating the function of the forward command button 47 upon activation.

FIG. 13 shows the open window of the authoring program 22 during composition of the graphical element 26 depicting color customization for the individual vehicles being displayed in the display area 26a. In accordance with one feature of this invention, both the color customization buttons 43a through 43e and background customization buttons 44a through 44e can be activated while the user is viewing an image of the vehicle in the display area 26a. FIG. 13A shows the code for the program regulating the function of one button 43a of the color customization buttons upon activation.

FIG. 14 shows the open window of the authoring program 22 during composition of the background customization buttons 44a through 44e. FIG. 14A shows the code for the program regulating the function of one button 44a of the background customization buttons upon activation.

FIG. 15 shows the open window of the authoring program 22 during composition of the zoom in and out buttons 41 and 42. FIG. 15A shows the code for the program regulating the function of the zoom in button 41 upon activation, and FIG. 15B shows the code for the program regulating the function of the zoom out button 42 upon activation.

FIG. 16 shows the open window of the authoring program 22 during composition of the drag button 40. FIG. 16 also shows the code for the program regulating the function of the drag button 40 upon activation.

### Summary of Operation of the First Embodiment

The two separate movies 17 and 56 are created in the authoring program 22. The movie 17 of the graphical element 26 is first downloaded to the user's computer 18 and then the movie 56 of the automotive vehicle is downloaded and displayed in the display area 26a. The user by moving the pointer 64 appearing on the monitor screen 20 to the drop-down menu command button 46 and clicking on this button causes the sub-element 60 to drop-down as shown in FIG. 4C. The user then moves the pointer 64 to the desired model to be displayed and clicks on one of the window screens 61, 62 or 63. The movie 56 for this individual model is now downloaded in the display area 26a. Each model of the vehicle has its own movie made up of edited and sequenced photographs as discussed above.

As shown in FIG. 17, the user then selects a color for the vehicle being displayed by moving the pointer 64 to the desired color command button, for example button 43d, clicking on this button to change the color of the vehicle appearing in the display area 26a. In a similar manner as illustrated in FIG. 18, the user clicks on a background customization button, for example button 44a, to select a background on which the image of the vehicle is displayed. These backgrounds could be different colors, or urban, county, or ocean scenes. At this point the image of the vehicle appearing in the display area 26a is not moving. As shown in FIG. 19, the user now moves the pointer 64 to the play command button 50 on the controller menu after first pressing the open/close button 45 so that this menu drops down. Upon pressing the play command button 50, the image becomes animated and it appears on the screen a rotating model S500 Class Mercedes. Activation of the zoom command button 41 allows the image in the display area 26a to be reduced as depicted in FIG. 20, and the activation of the zoom command button 42 allows the image in the display area 26a to be enlarged as depicted in FIG. 21. The user may activate the drag button 40 by pointing, clicking, and dragging using the mouse 18c in a conventional manner, dragging the drag button 40 along the slide bar 58 to move from one frame to another, for example, in movie 56 from frame #3, to frame #5, and then to frame # 10.

Second Embodiment:

The second embodiment of this invention is similar to the first embodiment, except it includes the additional feature of displaying in the display area 26a interiors of different models of the automotive vehicle being advertised by the player file 16. In this second embodiment, as illustrated in FIGS. 22 through 24, the graphical element 26 includes three additional viewing windows: window 200 showing an exterior of one model of an automotive vehicle being advertised, window 202 showing a dealer's show room or other facility such as the service department, and window 204 showing an interior of one model of the automotive vehicle being advertised. By pointing and clicking on the window 200 movies of one model of the vehicle are displayed in the display area 26a. By pointing and clicking on the window 202 movies of the automotive dealer's facilities may be displayed in the display area 26a. The drag control button 40 allows the user to look at different segments of a 360 degree panoramic movie of the facility being displayed. By pointing and clicking on the window 204 movies of an interior of one model of the vehicle is displayed in the display area 26a.

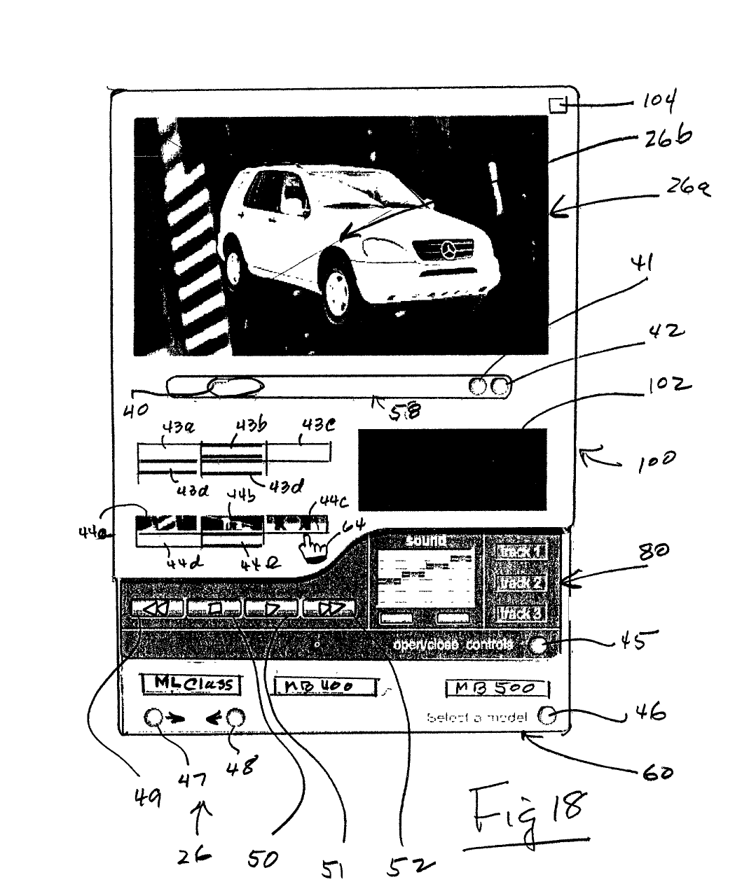

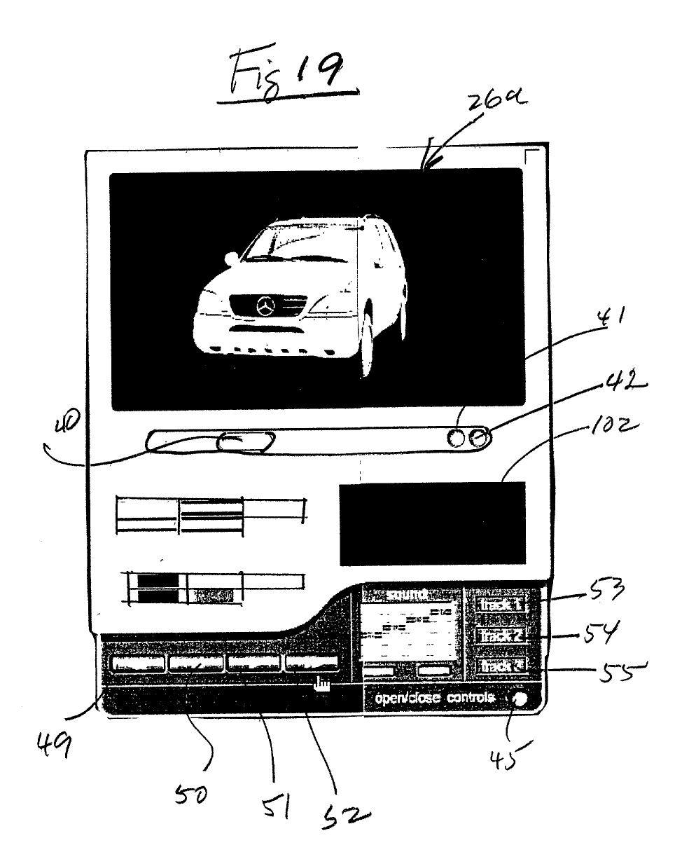

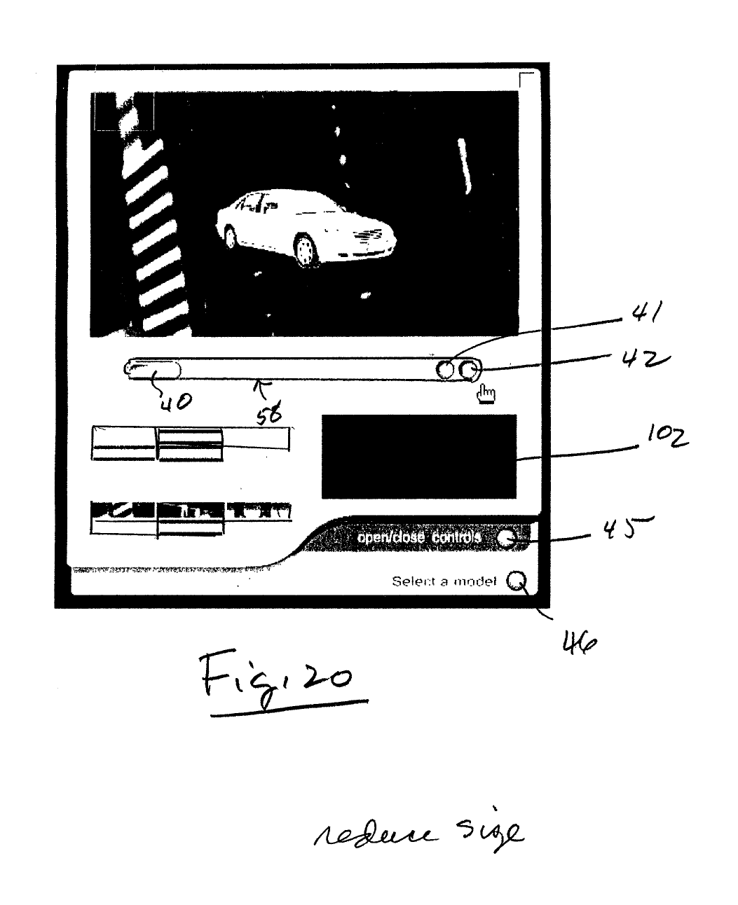

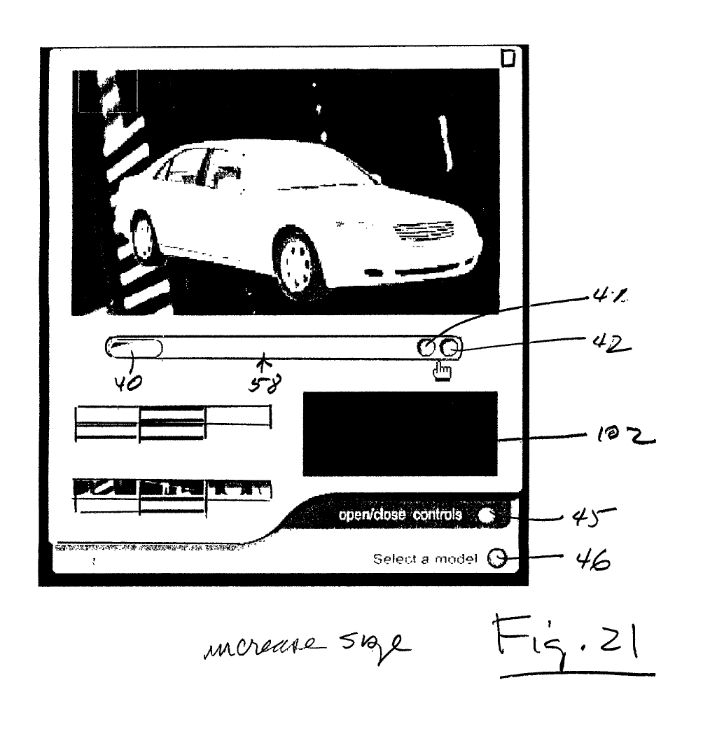

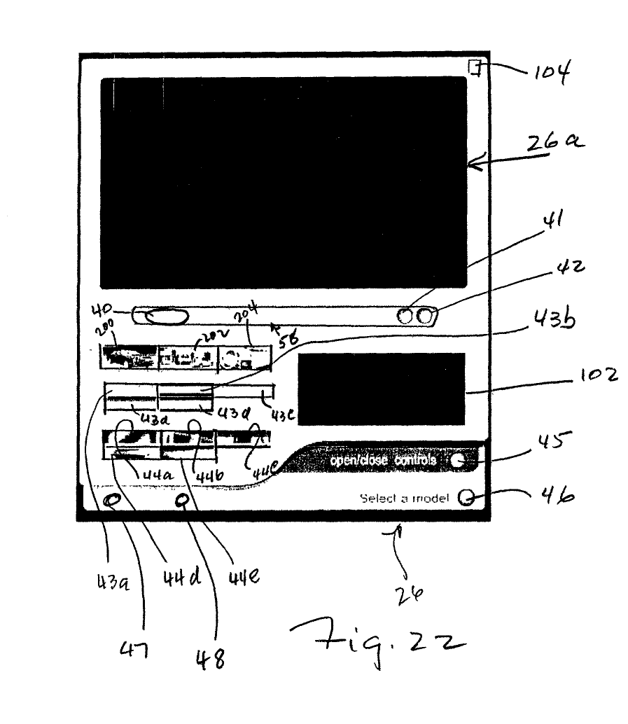

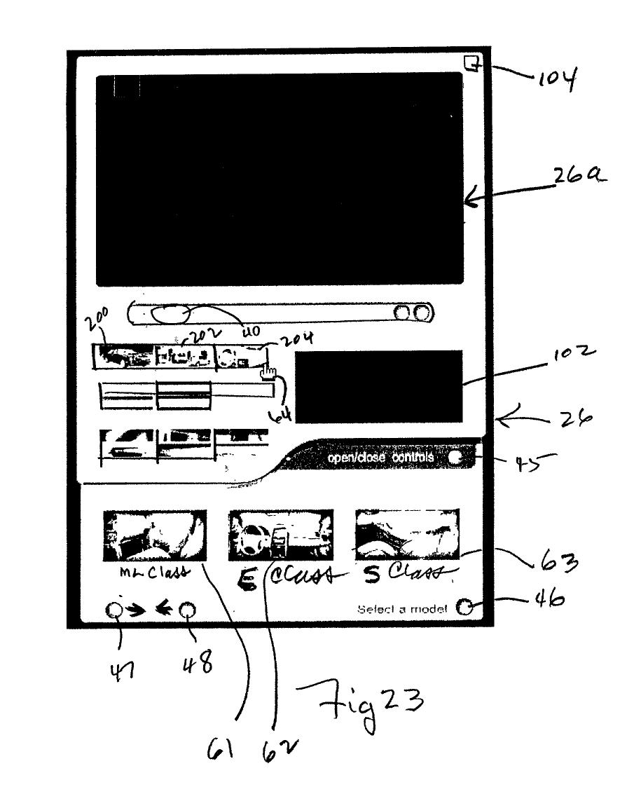

In accordance with this invention, both the exterior of the vehicle as discussed above in connection with the first embodiment of this invention and the interior of the selected model of the vehicle may be selectively displayed. A split display area (not shown) may be employed where both the vehicle's exterior and interior may be viewed by the user simultaneously. Or, each individually (the exterior or interior) may be displayed in the display area 26a as now discussed in connection with this second embodiment. To view the vehicle's interior the user first activates the model drop down menu graphical sub-element 60 by pointing and clicking on button 46. As depicted in FIG. 23, the user then points and clicks on the window 204 with the pointer 64. This causes a series of images of interiors of different models of the automotive vehicle to appear in the window screens 61, 62, and 63. Each are labeled with the model, for example, ML Class, E Class and S Class as shown in FIG. 23. As depicted in FIG. 24, pointing and clicking on the forward or reverse buttons 47 and 48 moves the images of the interiors of different models into and out of the window screens 61, 62, and 63. By pointing and clicking on one of these screens 61, 62, and 63 with the pointer 64, there appears in the display area 26a an image of the interior selected to be viewed. For example, as shown in FIG. 25, the pointer 64 is used to activate the window 61 showing the interior of a Mercedes Benz, Model ML Class.

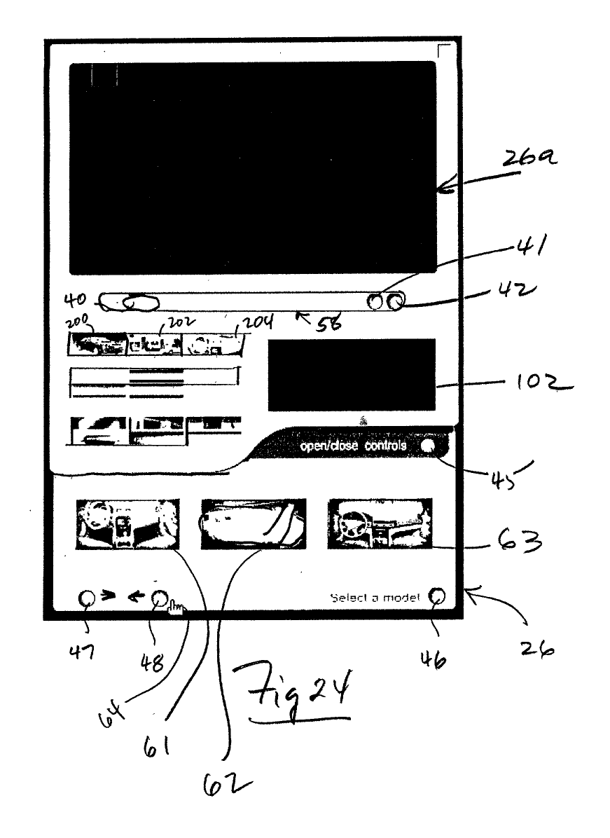

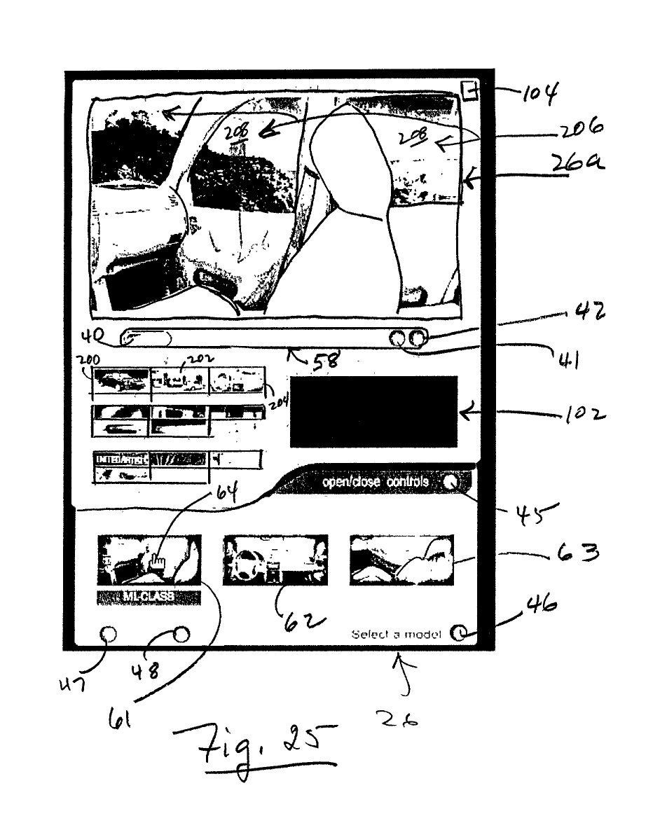

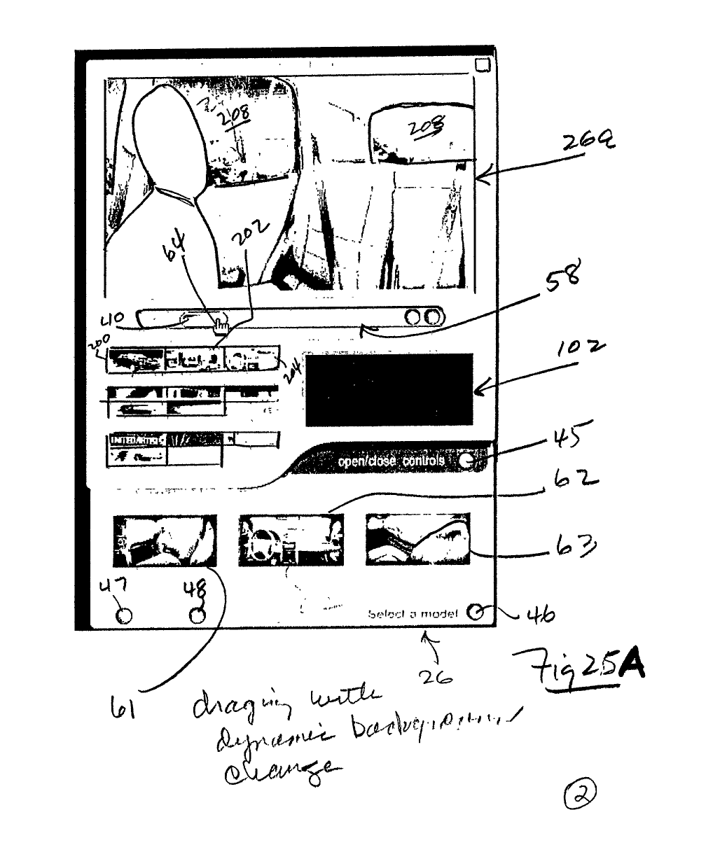

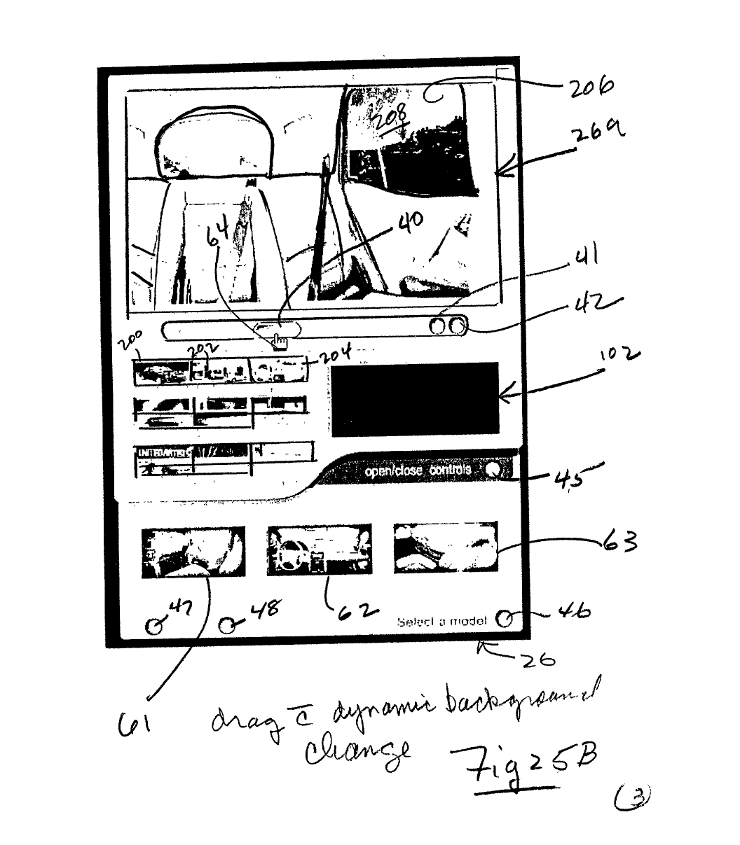

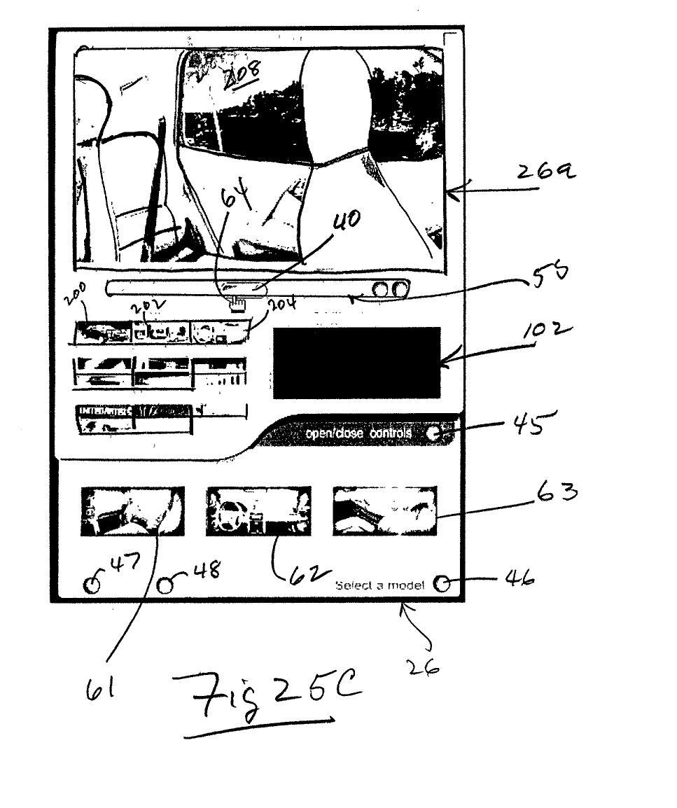

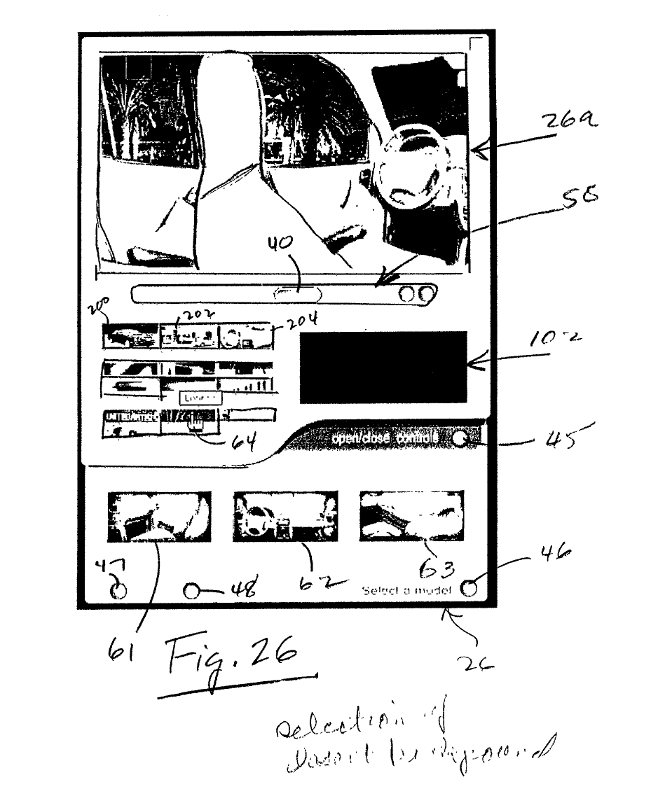

A unique feature of this invention is there appears in the display area 26a either a dynamic or static background image as if being viewed by an observer within the interior looking through the vehicle's windows 206. A dynamic background image 208 is depicted in FIGS. 25 through 25C and a static background image 210 is depicted in FIGS. 27A through 27C. As shown in FIG. 26, different background images, either dynamic or static, are selected by pointing and clicking on one of the control buttons 44a through 44e.

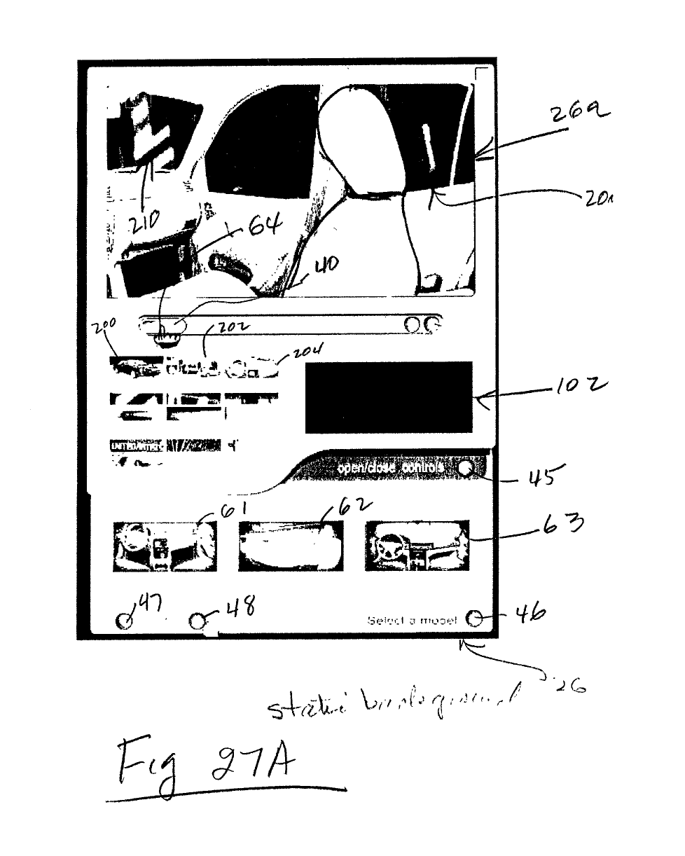

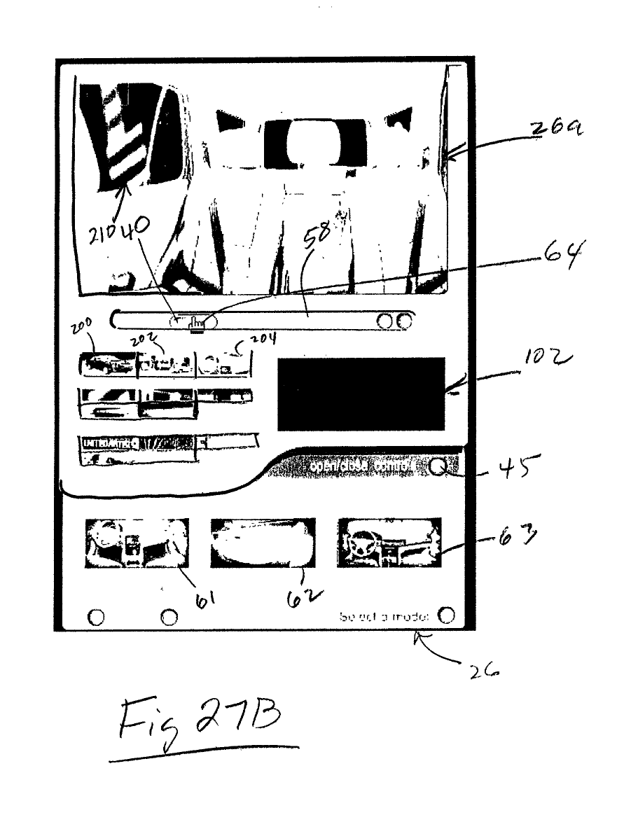

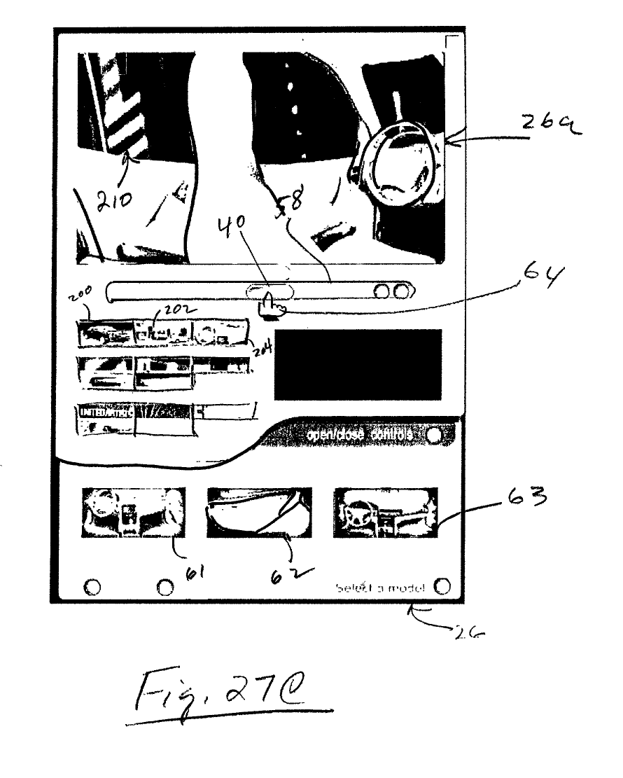

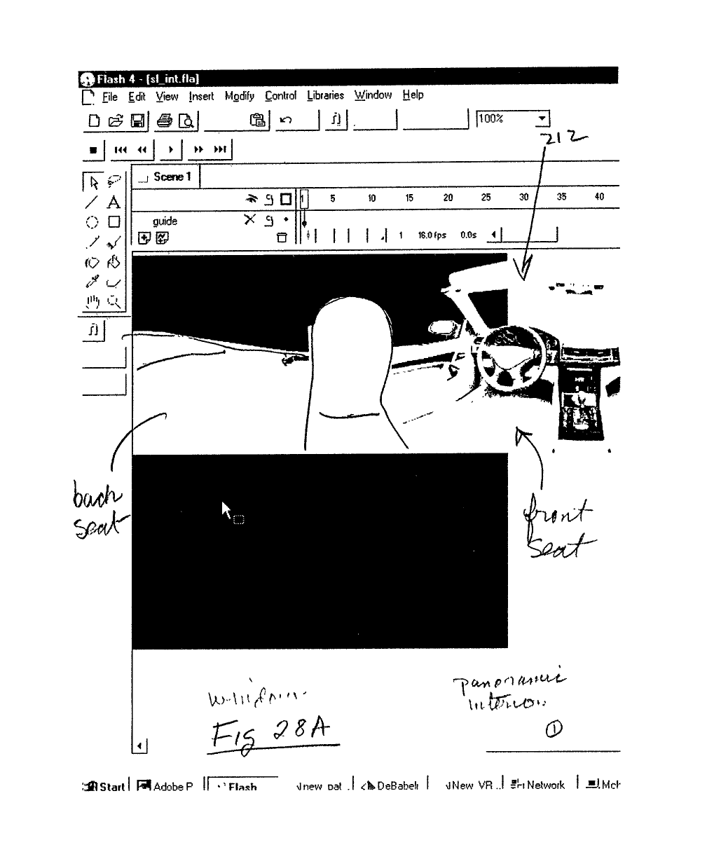

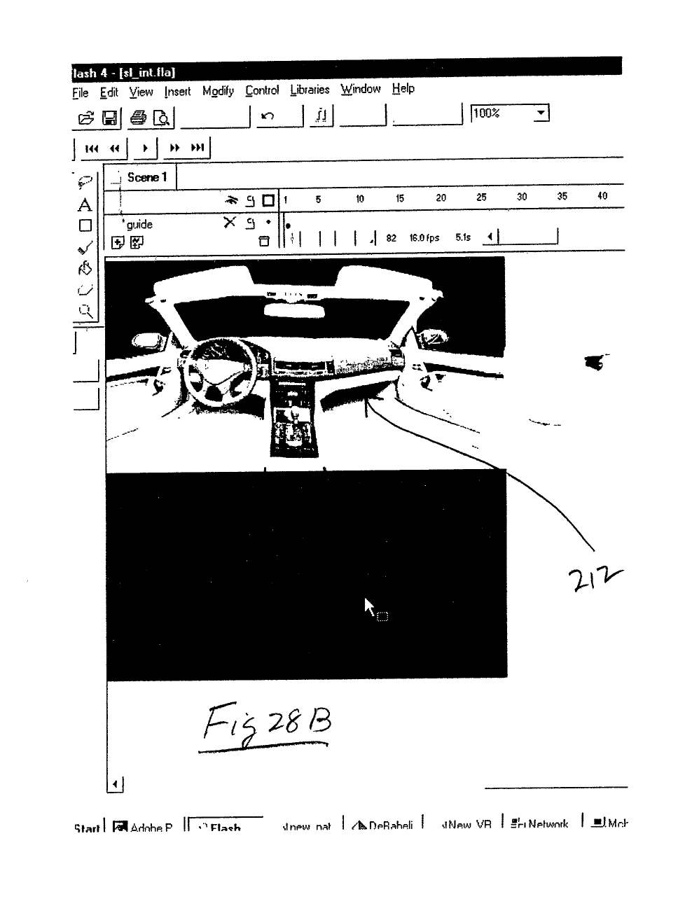

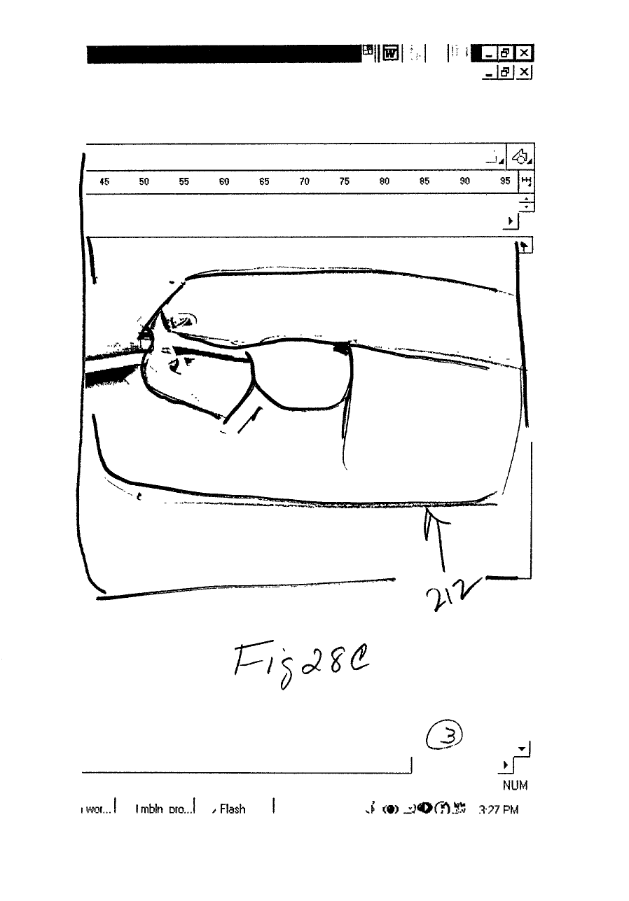

In accordance with this invention, first a series of photographs of the interior of one vehicle model are taken. Then, using the editing software program 23, the area corresponding to the windows 206 (FIG. 25) is extracted. This enables the background images 208 or 210 to be viewed through the cut-a-away or extracted portion corresponding to a vehicle's window areas. The individual edited photographs of the vehicle's interior are seamed together to create a single 360 degree panoramic image 212 of the interior as a file in the editing software program 23. This file of the 360 degree panoramic image 212 of the interior is downloaded into one layer in one FLASH movie file a s illustrated in FIGS. 28A through 28D. FIG. 28A is one edited segment of the 360 degree panoramic image 212 of the interior looking at the drivers side of the interior. FIG. 28B is a second edited segment of the 360 degree panoramic image 212 of the interior looking at the front side of the interior. FIG. 28C is a third edited segment of the 360 degree panoramic image 212 of the interior looking at the passenger side of the interior. FIG. 28D is a fourth edited segment of the 360 degree panoramic image 212 of the interior looking at the rear side of the interior.

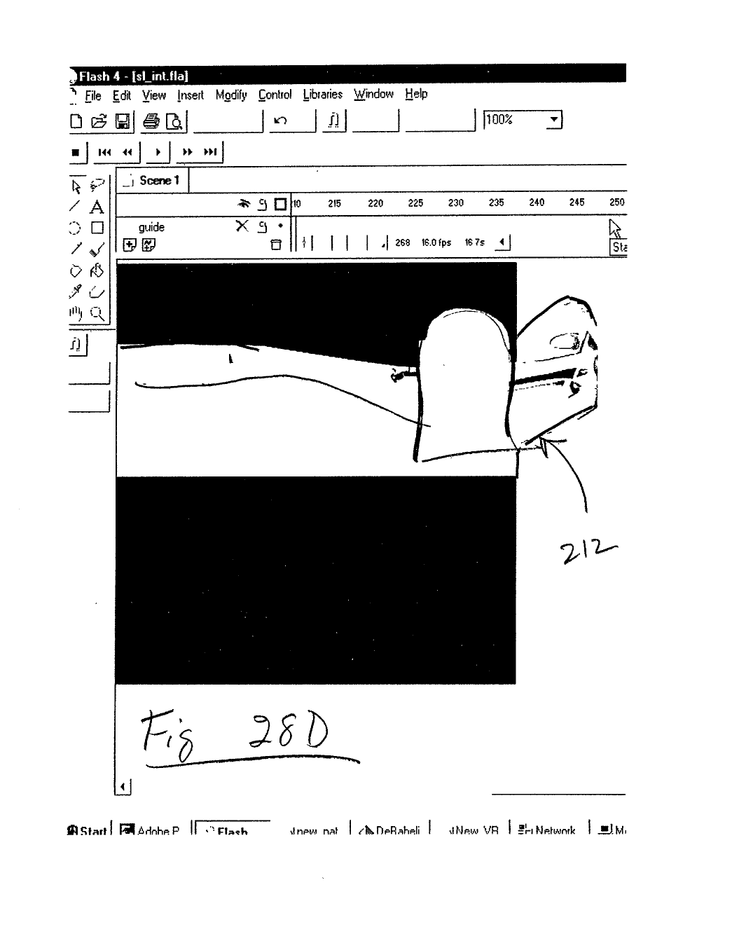

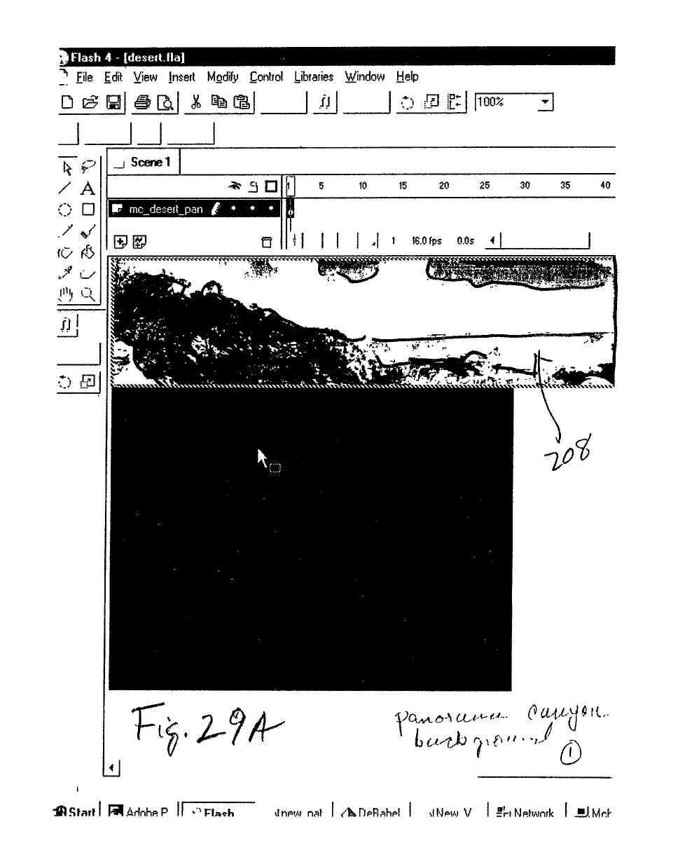

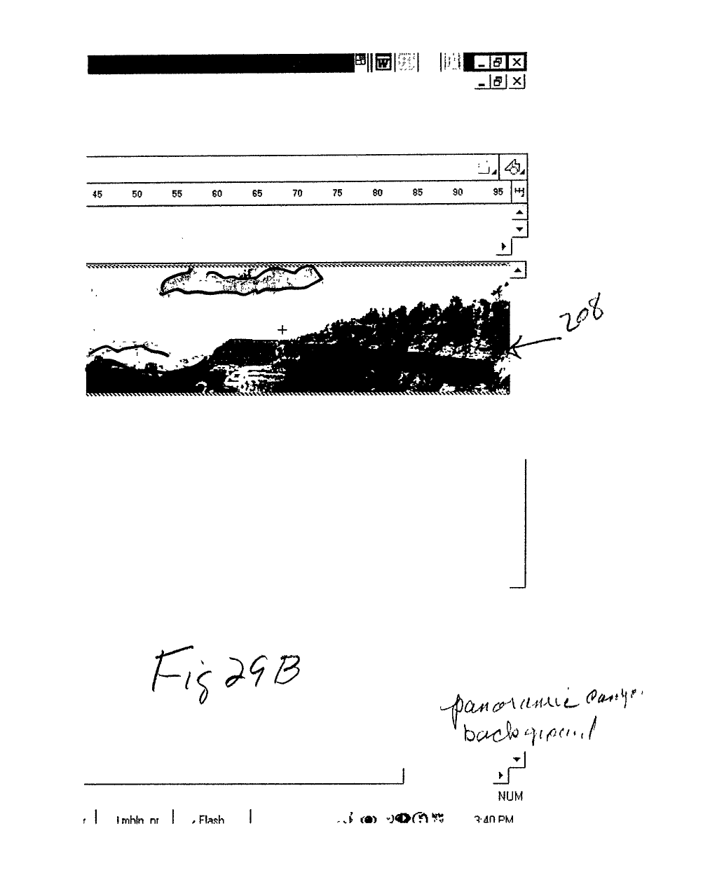

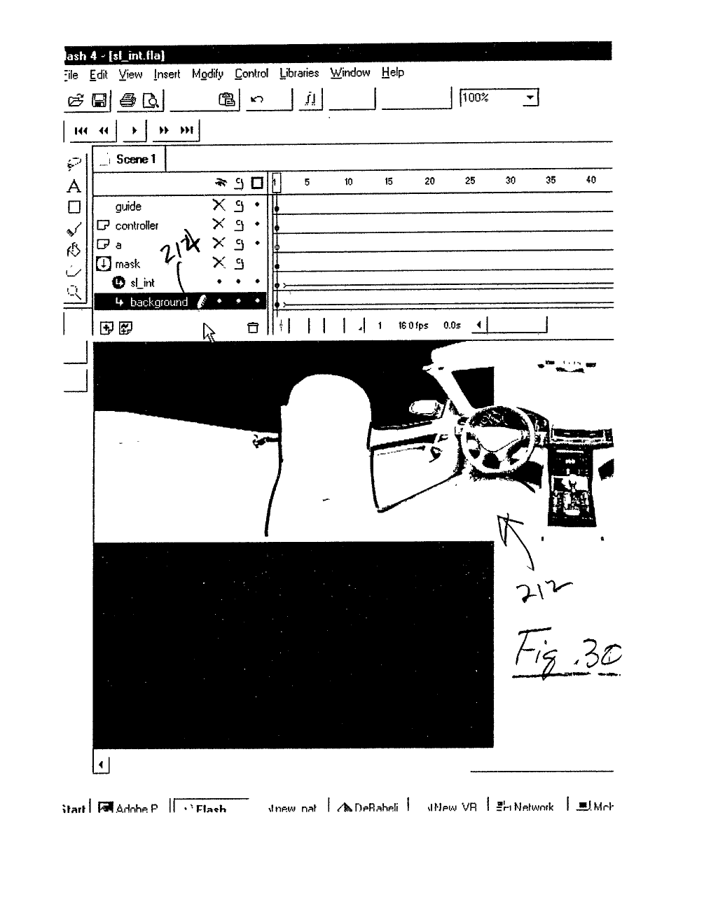

The background images 208 and 210 are created in the FLASH authoring program 22 as separate movies in different FLASH files and then loaded as separate layers in the FLASH file of the 360 degree panoramic image 212 of the interior. This allows either the dynamic background movie or static background movie to be played at the same time that the movie of the interior is being displayed in the display area 26a. For example, FIGS. 29A and 29B show a movie of a desert background being composed in one FLASH file. Then, as depicted in FIG. 30, this movie is loaded in the FLASH file of the 360 degree panoramic image 212 of the interior in the layer 214.

As illustrated in FIGS. 25 through 25C, when the user drags the control button 40 along the slider bar 58, different segments of the desert background image 208 as viewed by a stationary observer within the interior of the vehicle through the “extracted” windows 206. Segments of the desert background image 208 move in synchronization with the sequential movement of the different segments of the image of the vehicle's interior. This creates the illusion that a stationary observer within the interior of the vehicle sees the background changing as the vehicle rotates.

As illustrated in FIGS. 27A through 27C, when the user drags the control button 40 along the slider bar 58, the background image 210 as viewed by a stationary observer within the interior of the vehicle through the “extracted” windows 206 does not change positions. Consequently, this creates the illusion that a stationary observer within the interior of the vehicle sees the background image 210 remaining stationary as the vehicle rotates.

### Scope of the Invention

The above presents a description of the best mode contemplated of carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above which are fully equivalent. Consequently, it is not the intention to limit this invention to the particular embodiments disclosed. On the contrary, the intention is to cover all modifications and alternate constructions coming within the spirit and scope of the invention as generally expressed by the following claims, which particularly point out and distinctly claim the subject matter of the invention:

1. A method of creating and displaying an animated image of a first object, comprising the steps of
(a) taking in a predetermined sequence a series of individual photographs of the object, including portions any background matter,
(b) storing in the memory of a computer as individual digital images said individual photographs,
(c) editing the digital images to remove any image of the background matter,
(d) installing in the memory of the computer an authoring program for creating scalable, interactive animation of said edited and digital images, said authoring program being adapted to interact with a functional control program and having a storage section for imported digital images,
(e) importing into said storage section said edited digital images as individual bitmap images and storing said individual bitmap images in said predetermined sequence within said storage section, thereby enabling the authoring program to display on a screen of a computer monitor said individual bitmap images rapidly one after another to create an animated image of said object, and
(f) providing a functional control program that is interactive with the authoring program to display on said screen:
(A) a first control element that enables a user to select and to view on the screen the animated image of the object moving in either a forward direction or reverse direction through said sequence,
(B) a second control element that enables a user to select a zoom mode to modify the size of said animated image of the object, either increasing or decreasing said size of the animated image displayed on the screen, and to view on the screen said modified image,
(C) a third control element that enables a user to select any one of the individual bitmap images as a first frame of the animated image of said object.

2. The method of claim 1 including
importing into said storage section as individual bitmap images formatted and edited digital images of a second object and storing said individual bitmap images of said second object in a predetermined sequence within said storage section, thereby enabling the authoring program to display on the screen of the computer monitor said individual bitmap images rapidly one after another to create a n animated image of said second object, and
providing said functional control program with a fourth control element displayed on said screen that enables a user to switch between displaying on the screen the animated image of said second object and displaying on the screen the animated image of the first object.

3. The method of claim 1 providing said functional control program with a fifth control element displayed on said screen that enables a user to select one of a plurality of different backgrounds for the object being displayed on the screen.

4. The method of claim 1 where in step (c) the images are colorized.

5. The method of claim 4 where said functional control program is provided with a fifth control element displayed on said screen that enables a user to change the color of the object being displayed on the screen.

6. The method of claim 1 where the animated images are manipulated to rotated in sequence through 360 degrees.

7. The method of claim 1 where the animated images are transmitted via e-mail.

8. The method of claim 1 where the animated images are stored on a compact disk.

9. The method of claim 1 where the animated images are accessed over a global electronic communications network.

10. The method of claim 1 including installing a plug-in program that is compatible with the authoring program in a computer that a user employs to view on the user's computer monitor screen the animated image of the object.

11. The method of claim 9 where the authoring program provides for saving as an .swf file said animated image of the object.

12. The method of claim 11 where the .swf file is embedded within a html file adapted to be uploaded to a remote server.

13. The method of claim 1 where the object is placed on a stand that facilitates taking the photographs of the object at different angles.

14. A method of advertising a vehicle over a global electronic communications network comprising the steps of:
(a) placing the vehicle on a stand that enables a camera to take photographs at different angles of the vehicle, including portions of the stand and any background matter,
(b) taking with a camera at different angles a series of individual photographs of the vehicle, including portions of the stand and any background matter,
(c) storing said individual photographs in a predetermined sequence in the memory of a computer as individual digital images,
(d) editing the digital images to remove any image of the stand and the background matter
(e) formatting the edited digital images of the vehicle and storing in the memory of the computer said formatted edited digital images,
(f) installing in the memory of the computer an authoring program for creating scalable, interactive animation of said edited and formatted digital images, said authoring program being adapted to interact with a functional control program and having a storage section for imported digital images,
(g) importing into said storage section said formatted and edited digital images as individual bitmap images and storing said individual bitmap images in said predetermined sequence within said storage section, thereby enabling the authoring program to display on a screen of a computer monitor said individual bitmap images rotating in sequence through 360 degrees rapidly one after another to create an animated image of said vehicle,
(h) installing a plug-in program that is compatible with the authoring program in a computer that a user employs to view on a monitor screen of the user's computer the animated image of the vehicle,
(i) providing a functional control program that is interactive with the authoring program to display on said screen:
(A) a first control element that enables a user to select and to view on the screen the animated image of the vehicle moving in either a forward direction or reverse direction through said sequence,
(B) a second control element that enables a user to select a zoom mode to modify the size of said animated image of the vehicle, either increasing or decreasing said size of the animated image displayed on the screen, and to view on the screen said modified image,
(C) a third control element that enables a user to select any one of the individual bitmap images as a first frame of the animated image of said vehicle,
(j) saving in the authoring program as an .swf file said animated image of the vehicle,
(k) installing in the user's computer a plug-in program that is compatible with the authoring program to enable the animated image to be viewed on a monitor screen of the user's computer, and
(l) embedding said .swf file within a html file adapted to be uploaded to a remote server in the global electronic communications network accessed by a user's browser.

15. A method of advertising a vehicle wherein animated images of the vehicle are displayed on a monitor screen, comprising the steps of
(a) creating within an authoring software program a first movie of the vehicle in motion showing the exterior of the vehicle,
(b) creating within the authoring software program a second movie of the vehicle showing the interior of the vehicle from the view point of an observer seated within the vehicle and observing different portions of the interior of the vehicle,
(c) providing a functional control program that displays on said monitor screen a control element that enables a user to view the first movie and the second movie.

16. The method of claim 15 where the functional control program enables the user to select for viewing on the monitor screen either the first movie or the second movie.

17. The method of claim 15 where the functional control program enables the user to select for viewing simultaneously on the monitor screen the first movie and the second movie.

18. The method of claim 15 where said method is conducted over a global electronic communication network and the functional control program enables the user to make a purchase of the vehicle being advertised.

19. The method of claim 15 where the second movie includes a panoramic image of the interior of the vehicle, said panoramic image including windows through which a background scene appears as if being viewed by said observer seated within the vehicle.

20. The method of claim 19 where there are a plurality of different background scenes provided and the functional control program enables the user to select one of these background scenes to be displayed as the panoramic image of the interior of the vehicle is being displayed.

21. The method of claim 19 where the functional control program enables the user to select a first scenario where it appears that the background scene changes dynamically as viewed by the observer looking through the windows from the interior of the vehicle as the vehicle rotates.

22. The method of claim 19 where the functional control program enables the user to select a second scenario where it appears that the background scene remains static as viewed by the observer looking through the windows from the interior of the vehicle as the vehicle rotates.

23. A method of displaying on a monitor screen animated images of an object having an exterior and an interior, comprising the steps of
(a) creating within an authoring software program a first movie of the object in motion showing the exterior of the object,
(b) creating within the authoring software program a second movie of the object showing the interior of the object from the view point of an observer positioned within the object and observing different portions of the interior as the object moves,
(c) providing a functional control program that displays on said screen a control element that enables a user to view the first movie and the second movie.

24. The method of claim 23 where the control element enables the user to run selectively the movies in either a forward direction or a reverse direction.

25. The method of claim 23 where the control element enables the user to select a zoom mode for enlarging or reducing the size of the image of the object being displayed on the monitor screen.

26. The method of claim 23 where the control element enables the user to select and display on the monitor screen a single frame of the movie being run.

27. The method of claim 23 where the control element enables the user to change the color of the image of the object being displayed on the monitor screen.

27. The method of claim 20 where the control element enables the user to change backgrounds of the image of the object being displayed on the monitor screen.

28. A system for displaying animated images of an object, including
a computer with a monitor screen for displaying said animated images, and
a player file loaded into the computer for showing first and second movies simultaneously on the monitor screen, said first and second movies being composed in an authoring program in which (a) the first movie is a graphical element having a display area, and (b) the second movie is animated images of the object, said second movie being formatted for display in said display area of the first movie,
said player file including a functional control program providing a control element shown in the graphical element displayed on the monitor screen, said control element enabling a user to interact with the second movie as said second movie is displayed in the display area.

29. The system of claim 28 where the control element enables the user run the second movie selectively in either a forward direction or a reverse direction while being displayed.

30. The system of claim 28 where the control element enables the user to select a zoom mode for enlarging or reducing the size of the image of the object being displayed on the monitor screen.

31. The system of claim 28 where the control element enables the user to select and display on the monitor screen a single frame of the movie being run.

32. The system of claim 28 where the control element enables the user to change the color of the image of the object being displayed on the monitor screen.

33. The system of claim 28 where the control element enables the user to change backgrounds of the image of the object being displayed on the monitor screen.

34. The system of claim 28 where the first movie is downloaded prior to the second movie and then downloading the second movie.

35. The system of claim 28 including a reader file for accessing the player file and enabling the movies in the player file to be displayed on the monitor screen.
